(19) United States
(12) Patent Application Publication
(10) Pub. No.: US 2008/0239197 A1
(43) Pub. Date: Oct. 2, 2008

(54) Liquid crystal module and liquid crystal display device including the same

(75) Inventor: Koji Kasuga, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC LCD Technologies, Ltd., Kawasaki (JP)

(21) Appl. No.: 12/071,044

(22) Filed: Feb. 14, 2008

(30) Foreign Application Priority Data
Mar. 29, 2007 (JP) 2007-086192

(51) Int. Cl. G02F 1/1333

(52) U.S. Cl. 349/59

(57) ABSTRACT

To eliminate or reduce unevenness on a screen display generated due to distortion stresses generated because of small size differences or the like occurred during the time of processing or assembling. A liquid crystal module includes a liquid crystal panel for displaying an image, a backlight for irradiating light to the liquid crystal panel to light up the liquid crystal panel, and a shield plate for shielding electromagnetic waves from inside and outside, wherein the backlight is mounted to a frame-type chassis and a panel holding frame for holding the liquid crystal panel is provided thereto. The frame-type chassis and the panel holding frame are structured to be capable of being displaced in a direction approaching to or isolating from the screen of the liquid crystal panel by a displacement adjusting screw that is engaged either with the frame-type chassis or with the panel holding frame.

### CROSS-REFERENCE TO RELATED APPLICATION

This application is based upon and claims the benefit of priority from Japanese patent application No. 2007-086192, filed on Mar. 29, 2007, the disclosure of which is incorporated herein in its entirety by reference.

### BACKGROUND OF THE INVENTION

1. Field of the Invention

The present invention relates to a liquid crystal module and a liquid crystal display device including that liquid crystal module. More specifically, the present invention relates to a liquid crystal module and a liquid crystal display device including the liquid crystal module with which height positions of a panel holding frame for holding the liquid crystal panel and a frame-type chassis to which the panel holding frame is attached can be adjusted with respect to the liquid crystal panel.

2. Description of the Related Art

Recently, a monitor display (liquid crystal display device) using a thin liquid crystal module has been developed (see Japanese Unexamined Patent Publication 2005-283863 (Patent Document 1), for example).

In such a liquid crystal display device, thicknesses of a liquid crystal panel for displaying an image, a shield plate for shielding electromagnetic waves from the inside and outside, and a backlight for lighting up the liquid crystal panel are reduced for decreasing its weight, inversely, thereby weakening the rigidity of the liquid crystal module that configures the liquid crystal display device.

Thus, mechanical stresses are generated when assembling the liquid crystal module or when mounting the liquid crystal module into the device and become more likely to be imposed on the liquid crystal panel.

When such stresses are imposed on the liquid crystal panel, a panel gap thereof becomes fluctuated non-uniformly and transmittances at those areas of the panel become fluctuated. This generates uneven brightness of the display image, and the picture quality of the image will be deteriorated greatly. Recently, there have been an increased number of occasions where black-oriented screens are displayed in dark places, such as medical-use monitors, so that such unevenness in displays is particularly undesired.

Further, a liquid crystal display device having a structure shown in FIG. 28-FIG. 31 is known as a liquid crystal device using a thin liquid crystal module.

This liquid crystal display device 100 includes a liquid crystal module 101, and the liquid crystal module 101 includes a liquid crystal panel 103. A driver 104 used for driving and a substrate 105 for supplying signals to the driver 104 are connected to the liquid crystal panel 103. A panel unit 102 includes the liquid crystal panel 103, the driver 104, and the substrate 105.

The driver 104 is formed as a flexible tape type, so that it can be fixed to a backlight 106 by having a part thereof bent towards the rear side of the backlight 106.

An external shape of the backlight 106 is a resin-molded frame-type chassis 107. Although not shown, a lamp as a light source, a light guide plate for guiding the light to be irradiated to the back surface of the panel, and an optical sheet for reflecting the light are loaded on the frame-type chassis 107.

A panel holding frames 108 are attached to the four corners of the frame-type chassis 107. These panel holding frames 108 are molded as one body with the frame-type chassis 107 by a same material, and they form an L-shaped wall when viewed two-dimensionally. The internal size of the panel holding frames 108 is designed to be slightly larger than the external size of the liquid crystal panel 103, so that the panel unit 102 including the liquid crystal panel 103 can be fitted within the panel holding frames 108.

The panel holding frames 108 may also be formed in L-shape with a missing corner, i.e. two pieces of block-type members are placed in orthogonal directions from each other, and are arranged in such manner that one end of one block face against one end of the other block.

On a half-finished product in an above-described state, a shield plate 109 formed by processing a sheet metal is placed and fixed over the panel unit 102 and the panel holding frame 108. Thus, the liquid crystal module 101 is completed. The shield plate 109 is fixed to the backlight 106 by nails, fittings, or screws.

The liquid crystal module 101 is enclosed between a resin-molded box-type front-side device casing 110 with an opening in the center of the surface and a plate-type back-side device casing 111. The liquid crystal display device 100 includes the liquid crystal module 101, the front-side device casing 110, and the back-side device casing 111.

A screw hole (not shown) is provided at each of the four corners of the surface of the shield plate 109, and the liquid crystal module 101 is fixed to the front-side device casing 110 through the screws (not shown) that are screwed into the screw holes in the four corners of the shield plate 109. The front-side device casing 110 is fixed to the back-side device casing 111 by nails, fittings, or screws.

However, with the liquid crystal display device 100 shown in FIG. 28-31, distortion stresses are applied to the liquid crystal panel 103 because of small size differences or the like during the time of processing or assembling. This causes such an issue that unevenness is generated in display.

First, reasons for having such unevenness generated when the stress is applied to the liquid crystal panel 103 will be described.

Normally, the liquid crystal panel 103 is formed by laminating two glass plates, and a liquid crystal is enclosed therebetween. A panel gap of about several μmm is formed between the two glass plates. For uniformly stabilizing and maintaining the size of the gap within a plane, globular spacers having a uniform diameter are dispersed or a large number of same-height structures are provided therebetween.

However, when there is such the distortion stresses that twist the liquid crystal panel 103 applied, the size of the gap between the two glass plates is easily changed. Thus, the size of the gap in each part within the plane of the liquid crystal panel 103 becomes non-uniform.

In the meantime, although the liquid crystal panel 103 is a device that can obtain an arbitrary light transmittance by applying a prescribed voltage, the light transmittance is also fluctuated depending on the size of the gap.

Therefore, as described above, when such distortion stresses as described above are applied to the liquid crystal panel 103 to be twisted and the size of the gap in each part within the plane of the liquid crystal panel 103 becomes non-uniform, the light transmittances in each part within the plane also become non-uniform. As a result, the display on the screen becomes non-uniform, and that state on display is recognized as having “display unevenness”.

Further, the two glass plates that configure the liquid crystal panel 103 normally exhibit optical isotropy. However, when a stress is applied, the glasses exhibit birefringence. Thus, the polarizing characteristic of the liquid crystal panel 103 in a part where the stress is applied becomes changed. Therefore, the display also becomes non-uniform in this case, so that it is also recognized as having “display unevenness” on the display.

Described next is how the stress is applied to the liquid crystal panel 103 due to the distortion generated by the small size differences or the like during the time of processing or assembling.

As described above, in the related module structure, the liquid crystal panel 103 is fixed by being sandwiched between the frame-type chassis 107 and the shield plate 109.

Note here that the liquid crystal module 101 is desired to be narrow-framed, thin type, and light-weighted.

Further, the frame-type chassis 107 is made of a resin and formed in a frame shape, so that it means weak in terms of the strength. Furthermore, although the shield plate 109 is made of metal, it is thin and formed in a frame shape. Thus, the shied plate 109 is easily deformed in a twisted direction due to residual strains.

As described above, the liquid crystal panel 103 is sandwiched between the frame-type chassis 107 and the shield plate 109, which can be easily deformed. Thus, deformation in the twisted direction is propagated to the liquid crystal panel 103, and a repulsive force to the deformation works as the stresses.

The deformation in the twisted direction is generated because of distortions that are generated mainly due to the small size differences or the like which are occurred during the time of processing or assembling, such as the cases of a. to e. in the followings.
a. Distortion generated at the time of processing the frame-type chassis 107 and the shield plate 109
b. Assembling distortion generated due to small size differences of the components when mounting the lamp and the light guide plate into the frame-type chassis 107
c. Assembling distortion generated due to errors in the positions of the screws, nails, and fitting state, when fixing the shield plate 109 to the frame chassis 107
d. Assembling distortion in a direction of an arrow Z remained at the time of completing the liquid crystal module, as shown in FIG. 31A, which is caused due to the combined reasons of a. to c. described above
e. Assembling distortion in the arrow Z direction caused because of the small size differences in the positions of fixing screws 113 when the completed liquid crystal module is mounted to the device, as shown in FIG. 31B

In addition, as shown in FIG. 31C, when a foreign matter M enters between the liquid crystal panel 103 and the frame-type chassis 107, deformation also occurs in the liquid crystal panel 103 by being pushed up from the foreign matter as the origin. A repulsive force for this deformation works as the distortion stresses.

Further, as shown in FIG. 31D, when there is a deformed part 109A generated in a part of the shield plate 109 and the deformed part 109A comes in contact with the liquid crystal panel 103, the deformation also occurs in the liquid crystal panel 103 by being pushed down from the contact part as the origin. A repulsive force for this deformation works as the distortion stresses.

Furthermore, even if there is no assembling distortion generated during the time of completing the liquid crystal module, when there is generated a difference in distribution of the temperatures by the heat of the lamp when it is lighted up or when there is generated a difference in thermal expansion properties of the structural components due to a change in the surrounding temperature and humidity, irregular deformations occur. Thus, repulsive forces for those deformations work as the distortion stresses to the liquid crystal panel 103.

The above-described distortions remained at the time of processing or assembling have the size of one (1) mm or less, which is very small so that it cannot be detected during the assembling process, and is often found in a screen display test conducted after the assembling.

Therefore, when a distortion is discovered in a product, first, it is necessary first to check whether or not the product is being assembled without a distortion. Thus, it is necessary to disassemble the product by following reversed steps of assembling, to change the assembling condition, designed sizes of the components, etc. in order to remove the causes for the distortion, to evaluate the conditions, and to reassemble the components.

As a result, in order to correct the distortion generated during the time of processing or assembling and eliminate or reduce unevenness of the display, the components need to be disassembled and reassembled repeatedly many times depending on the reasons. This work causes troublesome and wastes a lot of time and effort.

Further, the liquid crystal module disclosed in Patent Document 1 mentioned above is also formed thin-type as a whole. Therefore, it is also expected to have those inconveniences generated in the thin-type liquid crystal display device 100 that uses the liquid crystal module shown in FIG. 28-FIG. 31 described above.

### SUMMARY OF THE INVENTION

An exemplary object of the present invention is to provide a liquid crystal module and a liquid crystal display device including the liquid crystal module that is capable of eliminating or reducing unevenness of a screen display easily within a short time, which is generated when the stresses imposed by a distortion that is generated due to small size differences or the like during the time of processing or assembling.

Further, another exemplary object of the present invention is to provide a liquid crystal module and a liquid crystal display device including the liquid crystal module which, even during assembling or after completing the product, is capable of eliminating or reducing unevenness of a screen display easily within a short time, which is generated when the stresses are imposed by a distortion that is generated due to small size differences or the like during the time of processing or assembling.

In order to achieve the foregoing exemplary objects, a liquid crystal display module and a liquid crystal display device including the liquid crystal display module according to an exemplary aspect of the invention are structured to be able to adjust the height positions of a frame chassis or a panel holding frames, which are structural components of the liquid crystal module, with respect to the liquid crystal panel. Thus, it enables the height positions thereof to be adjusted even after assembling the device, particularly after completing the liquid crystal module and after mounting the liquid crystal module into the liquid crystal display device.

Specifically, a liquid crystal module includes a liquid crystal panel for displaying an image, a backlight for irradiating light to the liquid crystal panel to light up the liquid crystal panel, and a shield plate for shielding electromagnetic waves from inside and outside, wherein the backlight is mounted to a frame-type chassis, and a panel holding frame for holding the liquid crystal panel is provided to the frame-type chassis. The frame-type chassis and the panel holding frame are structured to be capable of being displaced in a direction approaching to or isolating from a screen of the liquid crystal panel by a displacement adjusting member that is engaged either with the frame-type chassis or with the panel holding frame.

With this structure, when the displacement adjusting member is engaged either with the frame-type chassis or with the panel holding frame and operated, the frame-type chassis or the panel holding frame can be displaced in a direction approaching to or isolating from a screen of the liquid crystal panel. Therefore, even if the frame-type chassis or the panel holding frame is deformed from the distortion stresses generated because of the small size differences or the like which are occurred during the time of processing or assembling, the deformation can be corrected by pressurizing or pushing up the deformed part to obtain a normal state. As a result, unevenness on a screen display, which is generated from the distortion stresses generated because of the small size differences or the like which are occurred during the time of processing or assembling, can be eliminated or reduced easily within a short time.

As an exemplary advantage according to the invention, the frame-type chassis or the panel holding frame can be displaced in a direction approaching to or isolating from a screen of the liquid crystal panel by engaging the displacement adjusting member either with the frame-type chassis or with the panel holding frame and operating it. Therefore, even if the frame-type chassis or the panel holding frame is deformed due to the stresses caused by a distortion, the deformation can be corrected by pressurizing or pushing up the deformed part to obtain a normal state. As a result, unevenness on a screen display, which is generated from the distortion stresses, can be eliminated or reduced easily within a short time.

### BRIEF DESCRIPTION OF THE DRAWINGS

FIG. 1 is an overall detailed plan view showing a first exemplary embodiment of a liquid crystal module and a liquid crystal display device according to the present invention;

FIG. 2 is a fragmentary enlarged plan view showing the liquid crystal display device according to the first exemplary embodiment;

FIGS. 3A and 3B show fragmentary enlarged views of the liquid crystal display device according to the first exemplary embodiment, in which FIG. 3A is a longitudinal section taken along the line A-A of FIG. 2 and FIG. 3B is a longitudinal section taken along the line B-B of FIG. 2;

FIGS. 4A and 4B show illustrations for describing operations of the liquid crystal module according to the first exemplary embodiment, in which FIG. 4A shows a schematic view when a frame-type chassis is in a normal state and FIG. 4B is a plan view when the liquid crystal panel is in a normal sate;

FIG. 5 is an illustration for describing operations of the liquid crystal module according to the first exemplary embodiment, which is a fragmentary enlarged longitudinal section showing a state where the frame-type chassis, a shield plate, and the like are disposed in a normal manner;

FIGS. 6A and 6B show illustrations for describing operations of the liquid crystal module according to the first exemplary embodiment, in which FIG. 6A is a schematic illustration showing a state where the frame-type chassis is twisted in a prescribed direction from the state shown in FIGS. 4A and 4B, and FIG. 6B is a front elevational view showing a state of unevenness that appears on a screen of the liquid crystal panel when it is under the state shown in FIG. 6A;

FIGS. 7A and 7B show illustrations for describing operations of the liquid crystal module according to the first exemplary embodiment, in which FIG. 7A is a fragmentary enlarged longitudinal section showing a state of the frame-type chassis, the shield plate, and the like with respect to a reference plane under the state shown in FIG. 6A, and FIG. 7B is a fragmentary enlarged longitudinal section showing a state after the state shown in FIG. 7A is adjusted;

FIG. 8 shows illustrations for describing operations of the liquid crystal module according to the first exemplary embodiment, which is a schematic illustration showing a state where the frame-type chassis is twisted in a prescribed direction from the state shown in FIGS. 4A and 4B;

FIGS. 9A and 9B show illustrations for describing operations of the liquid crystal module according to the first exemplary embodiment, in which FIG. 9A is a fragmentary enlarged longitudinal section showing a state of the frame-type chassis, the shield plate, and the like with respect to a reference plane at a B part of FIG. 8, and FIG. 9B is a fragmentary enlarged longitudinal section showing a state after the state of FIG. 9A is adjusted;

FIGS. 10A and 10B show illustrations for describing operations of the liquid crystal module according to the first exemplary embodiment, in which FIG. 10A is a fragmentary enlarged longitudinal section showing a state of a deformed part of the shield plate, the frame-type chassis, and the like with respect to the reference plane, and FIG. 10B is a fragmentary enlarged longitudinal section showing a state after the state of FIG. 10A is adjusted;

FIG. 11 is an overall detailed plan view showing a second exemplary embodiment of a liquid crystal module and a liquid crystal display device according to the present invention;

FIG. 12 is a fragmentary enlarged plan view showing the liquid crystal display device according to the second exemplary embodiment;

FIGS. 13A and 13B show fragmentary enlarged views of the liquid crystal display device according to the second exemplary embodiment, in which FIG. 13A is a longitudinal section taken along the line A-A of FIG. 12, and FIG. 13B is a longitudinal section taken along the line B-B of FIG. 12;

FIG. 14 is a fragmentary enlarged plan view showing a liquid crystal module and a liquid crystal display device according to a third exemplary embodiment of the present invention;

FIGS. 15A and 15B show fragmentary enlarged views of the liquid crystal display device according to the third exemplary embodiment, in which FIG. 15A is a longitudinal section taken along the line A-A of FIG. 14, and FIG. 15B is a longitudinal section taken along the line B-B of FIG. 14;

FIGS. 16A and 16B show illustrations for describing operations of the liquid crystal module according to the third exemplary embodiment, in which FIG. 16A is a schematic illustration showing a state where a foreign matter is included in the liquid crystal panel, and FIG. 16B is a front elevational view showing a state of unevenness that appears on a screen of the liquid crystal panel when it is under the state shown in FIG. 16A;

FIGS. 17A and 17B show illustrations for describing operations of the liquid crystal module according to the third exemplary embodiment, in which FIG. 17A is a fragmentary enlarged longitudinal section of the B part of FIG. 16A before being adjusted, and FIG. 17B is an illustration showing a state after it is adjusted from the state of FIG. 17A;

FIG. 18 is an overall detailed plan view showing a fourth exemplary embodiment of a liquid crystal module and a liquid crystal display device according to the present invention;

FIG. 19 is a fragmentary enlarged plan view showing the liquid crystal display device according to the fourth exemplary embodiment;

FIGS. 20A and 20B show fragmentary enlarged views of the liquid crystal display device according to the fourth exemplary embodiment, in which FIG. 20A is a longitudinal section taken along the line A-A of FIG. 19, and FIG. 20B is a longitudinal section taken along the line B-B of FIG. 19;

FIG. 21 is an overall detailed plan view showing a fifth exemplary embodiment of a liquid crystal module and a liquid crystal display device according to the present invention;

FIG. 22 is a fragmentary enlarged plan view showing the liquid crystal display device according to the fifth exemplary embodiment;

FIGS. 23A and 23B show fragmentary enlarged views of the liquid crystal display device according to the fifth exemplary embodiment, in which FIG. 23A is a longitudinal section taken along the line A-A of FIG. 22, and FIG. 23B is a longitudinal section taken along the line B-B of FIG. 22;

FIG. 24 is an overall detailed plan view showing a sixth exemplary embodiment of a liquid crystal module and a liquid crystal display device according to the present invention;

FIG. 25 is an overall detailed plan view showing a seventh exemplary embodiment of a liquid crystal module and a liquid crystal display device according to the present invention;

FIG. 26 is a fragmentary enlarged plan view showing the liquid crystal display device according to the seventh exemplary embodiment;

FIGS. 27A and 27B show fragmentary enlarged views of the liquid crystal display device according to the seventh exemplary embodiment, in which FIG. 27A is a longitudinal section taken along the line A-A of FIG. 26, and FIG. 27B is a longitudinal section taken along the line B-B of FIG. 26;

FIG. 28 is an overall detailed plan view showing a liquid crystal module and a liquid crystal display device according to a related technique;

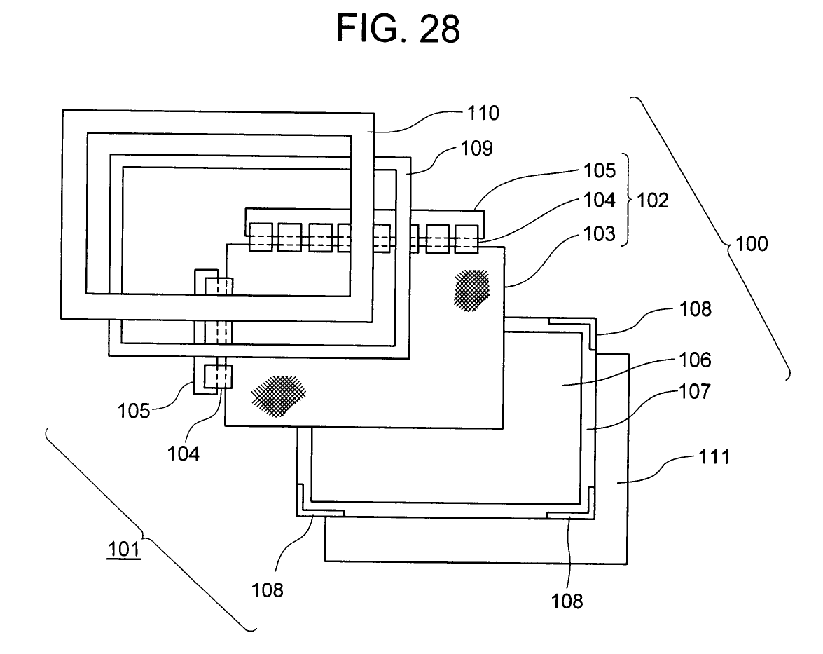

FIG. 29 is a fragmentary enlarged plan view showing the liquid crystal display device according to the related technique;

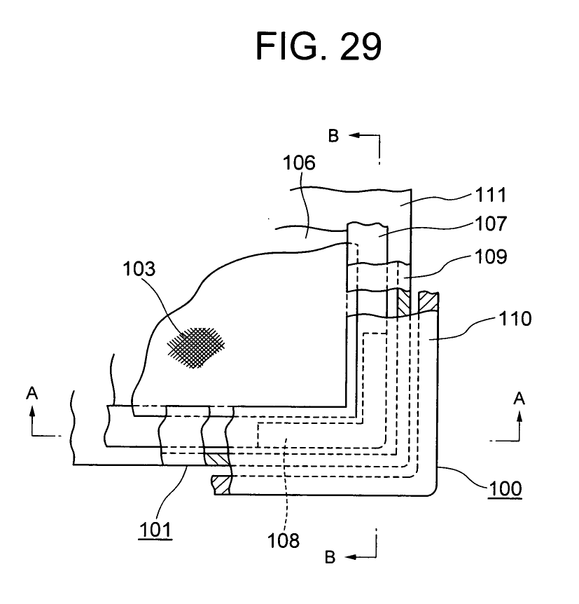

FIGS. 30A and 30B show fragmentary enlarged views of the liquid crystal display device according to the related technique, in which FIG. 30A is a longitudinal section taken along the line A-A of FIG. 29, and FIG. 30B is a longitudinal section taken along the line B-B of FIG. 29; and

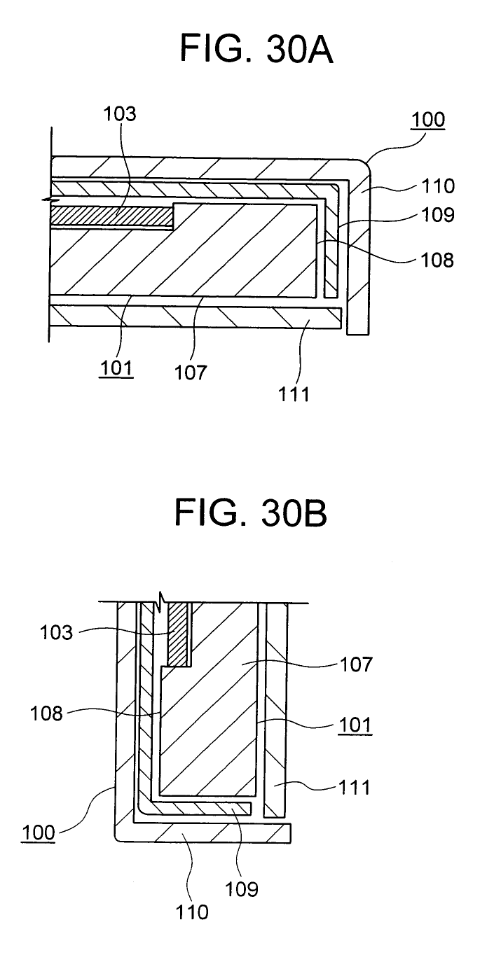

FIGS. 30A-30D show states of unevenness generated due to distortions of the liquid crystal display device of the related technique, in which FIG. 31A is a schematic plan view of the unevenness generated because of distortion of the module, FIG. 31B is a schematic plan view of the unevenness generated due to a stress applied by a foreign matter, FIG. 31C is a schematic plan view of the unevenness generated because of distortion generated at the time of mounting the module into the device, and FIG. 31D is a schematic plan view of the unevenness generated due to a contact stress.

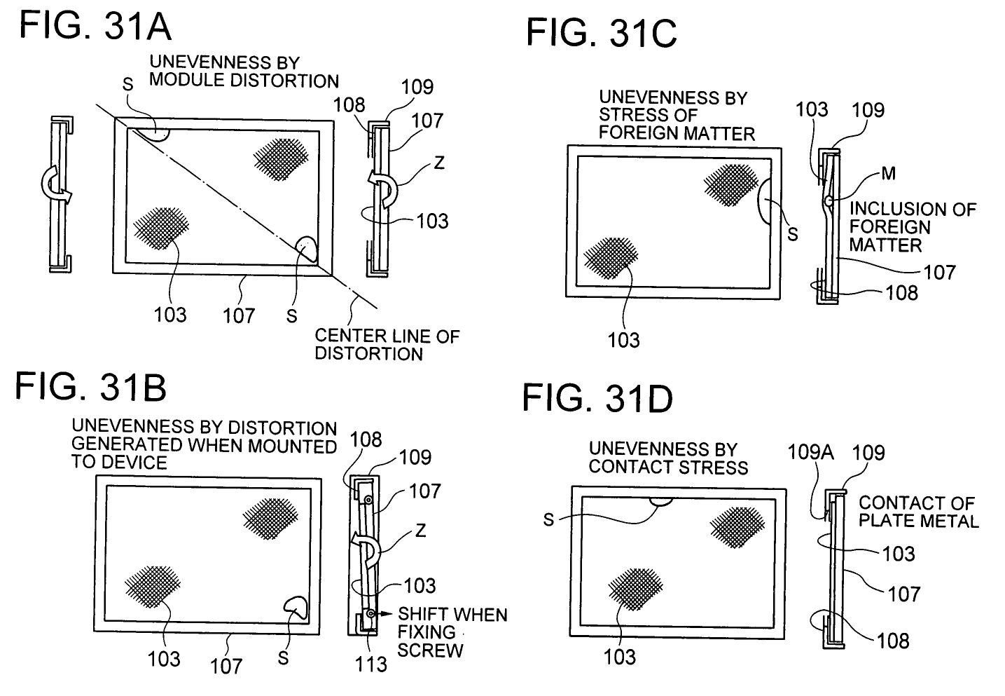

### DETAILED DESCRIPTION OF THE EXEMPLARY EMBODIMENTS

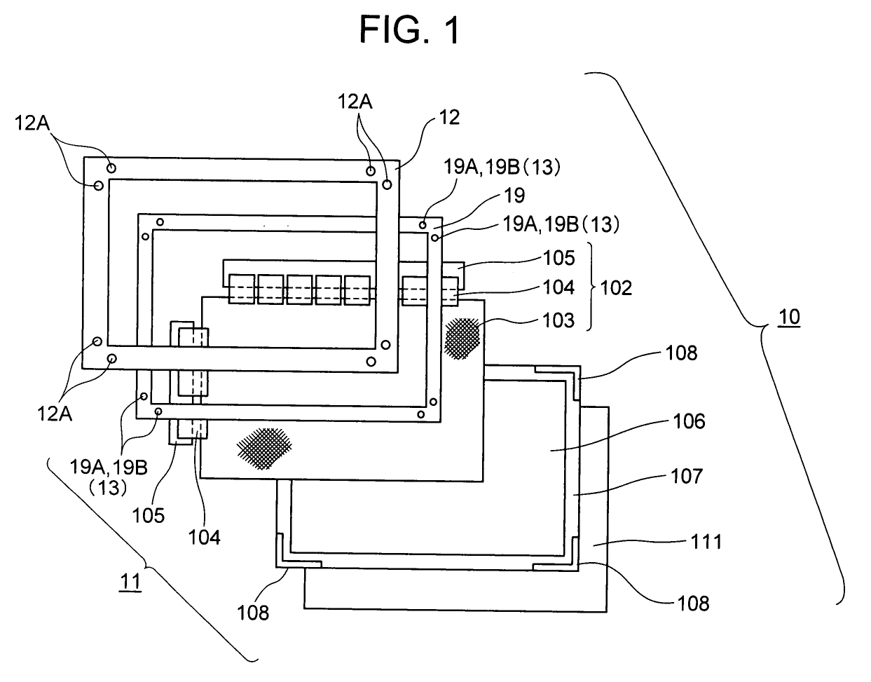

Hereinafter, a liquid crystal module and a liquid crystal display device including the liquid crystal module according to a first exemplary embodiment of the present invention will be described by referring to FIG. 1-FIGS. 10A and 10B.

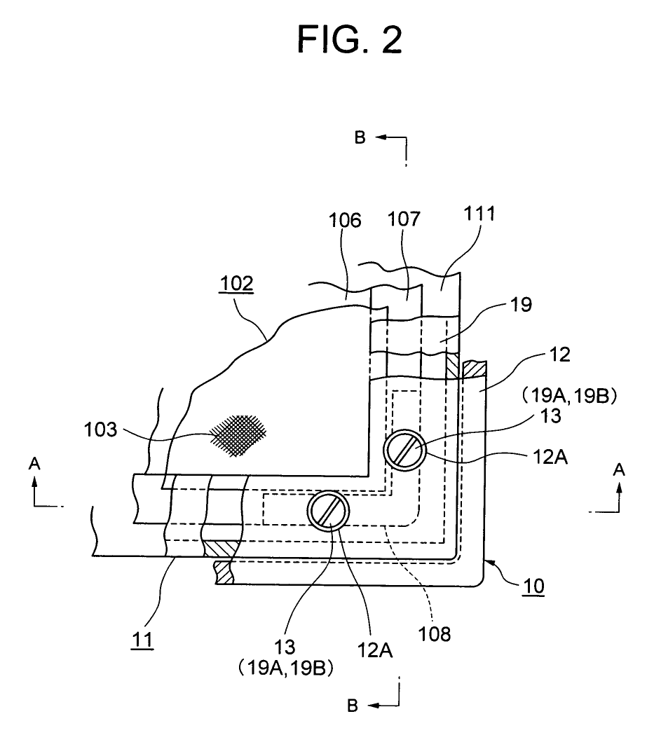

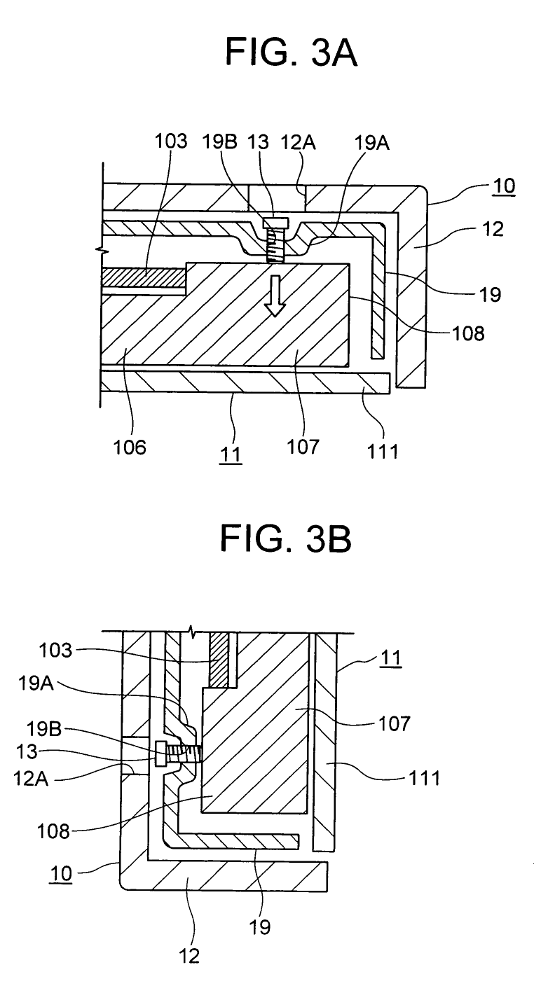

FIG. 1-FIGS. 3A and 3B illustrate the liquid crystal module and the liquid crystal display device including the liquid crystal module according to the first exemplary embodiment. FIG. 1 is a detailed perspective view of a liquid crystal display device 10 of the first exemplary embodiment, FIG. 2 is a fragmentary enlarged plan view of the liquid crystal display device 10, FIG. 3A is a longitudinal section thereof taken along the line A-A of FIG. 2, and FIG. 3B is a longitudinal section thereof taken along the line B-B of FIG. 2.

As exemplary embodiments of the present invention, first to seventh exemplary embodiments will be described hereinafter. In each exemplary embodiment, same reference numerals as those of the liquid crystal module 101 and the liquid crystal display device 100 according to the related technique are applied to those having same structures and using same materials. Further, same reference numerals are employed for the components that have same structures and use same materials in each of the exemplary embodiments, and detailed explanations thereof are omitted or simplified. In each exemplary embodiment, the structural components that are peculiar to that specific embodiment will be described in detail.

A liquid crystal module 11 of the liquid crystal display device 10 according to the first exemplary embodiment includes a frame-type chassis 107 and panel holding frames 108. The height positions of the frame-type chassis 107 and the panel holding frames 108 are moved vertically by adjuster screws 13 (displacement adjuster screws) and elasticity of the materials. That is, the height positions of the frame-type chassis 107 and the panel holding frames 108 can be adjusted by being displaced in directions approaching and isolating to/from a screen of the liquid crystal panel.

That is, the liquid crystal module 11 includes a panel unit 102 and, as described above, it is placed within the panel holding frames 108.

As in the case of the related technique, a shield plate 19 formed by processing a plate metal is covered over the panel unit 102 and fixed thereto, thereby completing the liquid crystal module 11.

As shown in FIG. 3A and FIG. 3B, the shield plate 19 is formed in such a size that it can be enclosed inside a front-side device casing 12. The front-side device casing 12 is formed in a shape that is substantially the same as that of the front-side device casing 110 of the related technique, and the shield plate 19 is formed in a shape that is substantially the same as that of the shield plate 109 of the related technique.

The liquid crystal module 11 as described above is enclosed between the front-side device casing 12 and a back-side device casing 111.

As described above, the liquid crystal module 11 according to this exemplary embodiment is structured in such a manner that the frame-type chassis 107 and the panel holding frames 108 can be moved vertically.

As shown in FIG. 1 and FIG. 2, in the four corners of the surface of the shield plate 19, one each of a burring 19A is provided at two positions that are away from the each corner part by a prescribed distance. Accordingly, the burrings 19A are formed at a total of eight positions of the shield plate 19.

Each burring 19A is formed to be protruded in a shallow cup-like shape from the surface to the back side, and a screw hole 19B is formed in such burring 19A. The adjuster screw 13 as the displacement adjusting member is screwed into the screw hole 19B.

As shown in FIG. 3A, the shield plate 19 is fixed to a backlight 106 through nails, fittings, or screws like the structure of the related technique. Thus, when the adjuster screw 13 is turned and screwed into the hole under such condition, the tip of the adjuster screw 13 comes to make a contact with the upper part of the panel holding frame 108, as shown in FIG. 3B. The adjuster screw 13 is screwed further into the hole, and the tip of the adjuster screw 13 pushes down the panel holding frame 108. Therefore, the panel holding frame 108 and the frame-type chassis 107 can be displaced towards the downward direction. In FIG. 3A, however, nails, fittings, screws, and the like are not illustrated.

When the adjuster screw 13 is turned inversely to be loosened, the tip of the adjuster screw 13 is brought away from the upper part of the panel holding frame 108. As a result, the panel holding frame 108 and the frame-type chassis 107 are to return to the original positions because of the elasticity of the panel holding frame 108 and the frame-type chassis 107.

The amount of displacement is assumed to be within one (1) mm. However, this exemplary embodiment can also be applied when the amount of the displacement is over one (1) mm.

As described above, the burrings 19A are provided at a total of eight positions in the four corners of the surface of the shield plate 19, and the adjuster screw 13 is mounted to each burring 19A. Thus, tool inserting holes 12A are opened at corresponding positions of the burrings 19A and the adjuster screws 13 in the surface of the front-side device casing 12.

This tool inserting hole 12A is formed larger than the external diameter of the head of the adjuster screw 13, and it is formed in such a size that the tip of a fastening tool such as a driver can be inserted. As a result, it becomes possible to turn the adjuster screw 13 to tighten or loosen it by inserting the fastening tool such as the driver from the tool inserting hole 12A.

Next, operations of the first exemplary embodiment in the above-described structure will be described.

As described above, the liquid crystal panel 103 is placed over the backlight 106, and it is enclosed within the panel holding frames 108 positioned at the four corners of the frame-type chassis 107 and fixed by being sandwiched between the shield plate 19 and the frame-type chassis 107.

As described above, the frame-type chassis 107 is made of a resin and formed in a frame shape, so that it is weak in terms of the strength. Even though it is made of metal, the shield plate 19 is also thin and formed in a frame shape, so that it is deformed easily in twisted directions due to residual strains. The liquid crystal display panel 103 is sandwiched between the frame-type chassis 107 and the shield plate 19 which are deformed easily in the manner described above. Thus, when the deformation in the twisted direction is propagated to the liquid crystal panel 103, a repulsive force for the deformation works as the distortion stresses.

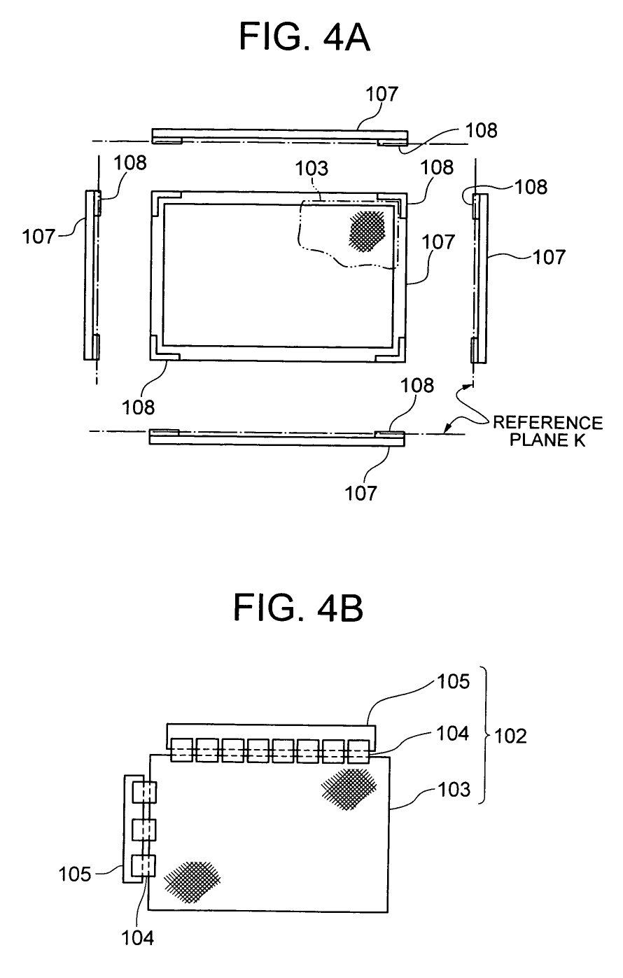

The first exemplary embodiment is structured in the manner described above, so that the deforming distortion for the liquid crystal panel 103 can be corrected, and the distortion stresses to the liquid crystal panel 103 can be released. The actions thereof will be described by referring to FIGS. 4A and 4B-FIGS. 10A and 10B.

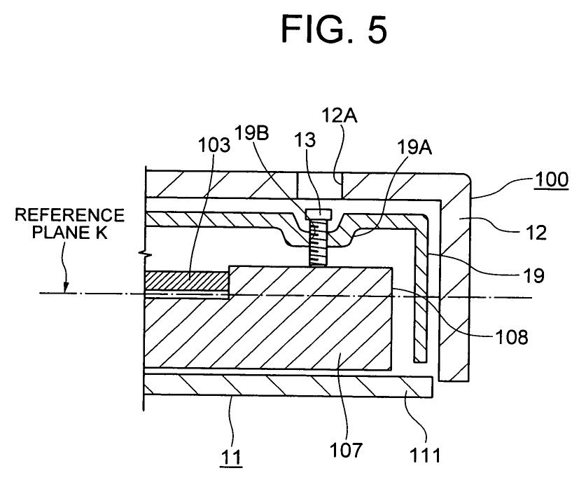

FIGS. 4A, 4B and FIG. 5 are illustrations for showing the state where there is no deformation generated in the liquid crystal panel 103. In FIG. 4A and FIG. 4B, a plane of the liquid crystal panel 103 or the like, i.e. a surface in parallel to the face of the paper, is assumed to be a reference plane K of the liquid crystal panel 103. When the liquid crystal panel 103 is placed on the reference plane K as shown in the longitudinal section of FIG. 5, it is assumed that the liquid crystal panel 103 is under an identical level state with no deformation.

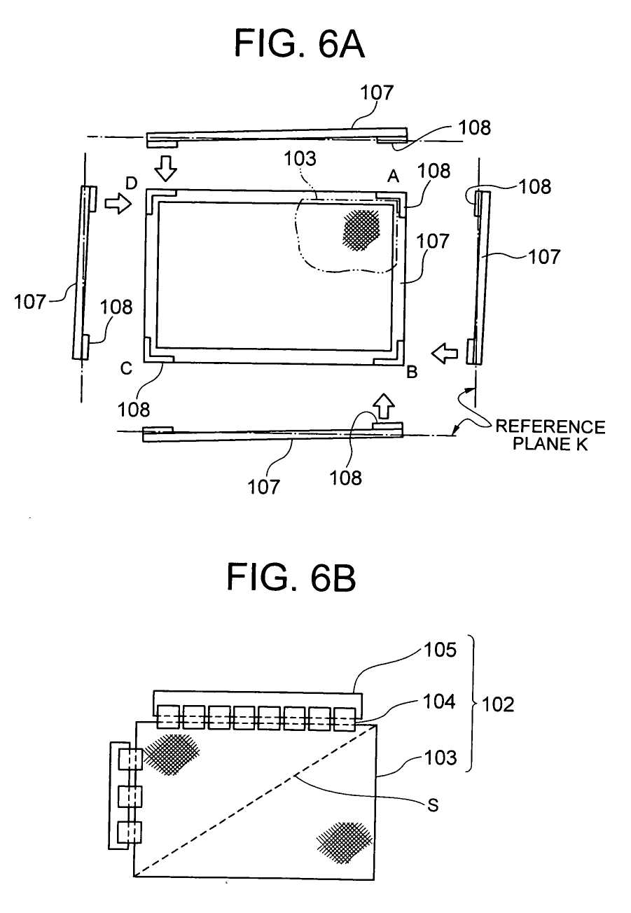

FIGS. 6A and 6B are illustrations for showing a state where the frame-type chassis 107 is deformed in the twisted direction from the posture of the ideal state described above.

Provided that the panel holding frames 108 positioned at the four corners of the frame-type chassis 107 are referred to as A part, B part, C part, and D part, respectively, from the upper right position on the plane towards the clockwise direction, the state described above is a state where the panel holding frames 108 at the B part and the D part is displaced towards the upper direction with respect to the reference plane K by being twisted.

When such deformation in the twisted direction is propagated from the frame-type chassis 107 to the liquid crystal panel 103, there is deformation generated as shown in FIG. 6B to valley-fold the liquid crystal display panel 103 along a broken line. This deformation is displayed on the screen of the liquid crystal panel 103 as unevenness S.

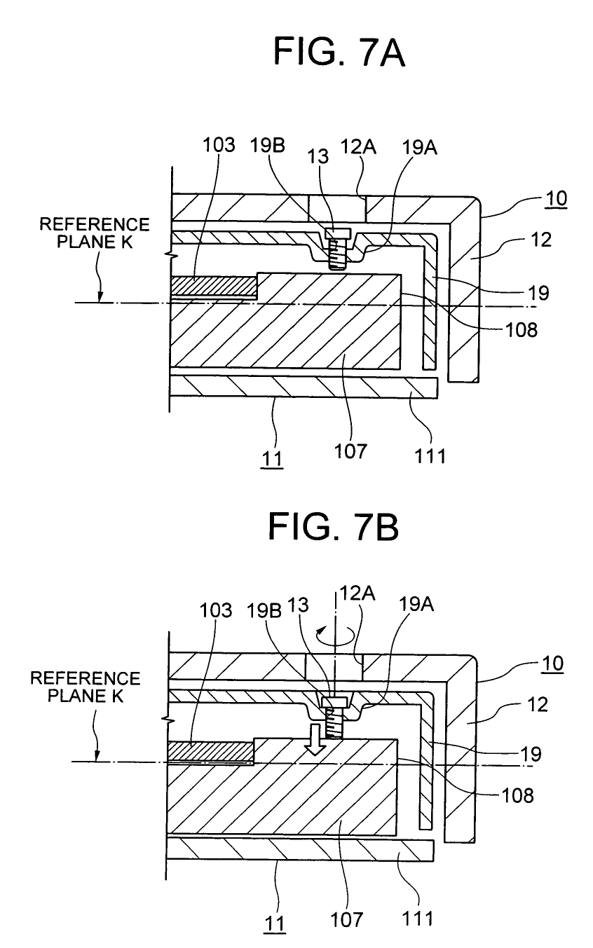

In order to correct such deformation, first, as shown in FIG. 7A and FIG. 7B which are longitudinal sections of the B part of FIG. 6A, a tip of a tool such as a driver is inserted from the tool inserting hole 12A of the front-side device casing 12, and two each of the adjuster screws 13 arranged at the positions of the B part and the D part among the four corners of the shield plate 19 are screwed in from the state shown in FIG. 7A.

Upon this, as shown in FIG. 7B, the tip of the adjuster screw 13 comes in contact with the top face part of an L-shaped wall of the panel holding frame 108. By further screwing the adjuster screw 13 into the tool inserting hole 12A, the panel holding frame 108 and the frame-type chassis 107 can be displaced towards the downward direction for the reference plane K. This is the same for the D part.

As a result, the B part and the D part can be returned to the reference plane K. At last, the four corners of the A part to D part can be aligned at the position of the reference plane K, thereby providing an ideal state.

The product at the point where the deformation is adjusted by the adjuster screws 13 is a complete product of the liquid crystal module 11 or the liquid crystal display device 10 capable of displaying a screen. Adjusting part of the adjuster screw 13 is provided on the surface of the shield plate 19 that is the utmost surface side of such product so that, practically, the adjuster screw 13 can be adjusted to the optimum position while checking the state of the unevenness S by driving the screen.

Further, since the tool inserting holes 12A are provided to the front-side device casing 12, it is also possible to insert a tool such as a driver from the tool inserting holes 12A to adjust the displacement by screwing the adjuster screws 13 therein, even under the state where the product is being mounted into the device.

Furthermore, since the adjuster screws 13 are exposed, the adjuster screws 13 can be adjusted to the optimum positions while checking the state of the unevenness S by actually driving the display.

In a case where deformation is generated at the A part and the C part, for example, the adjuster screws 13 at the positions of the A part and the C part may be adjusted in the same manner described above.

The above-described explanation is the action taken for the case where the panel holding frames 108 are displaced towards the upward direction from the reference plane K. However, it is also possible with this action to adjust the panel holding frames 108 when those are displaced towards the downwards direction from the reference plane K.

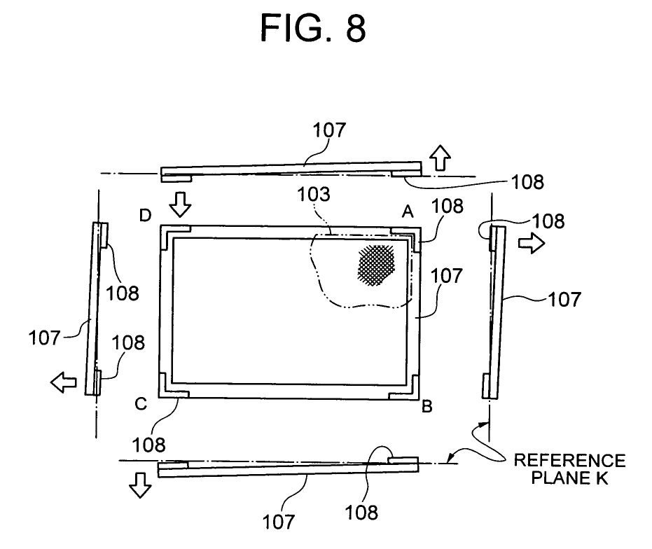

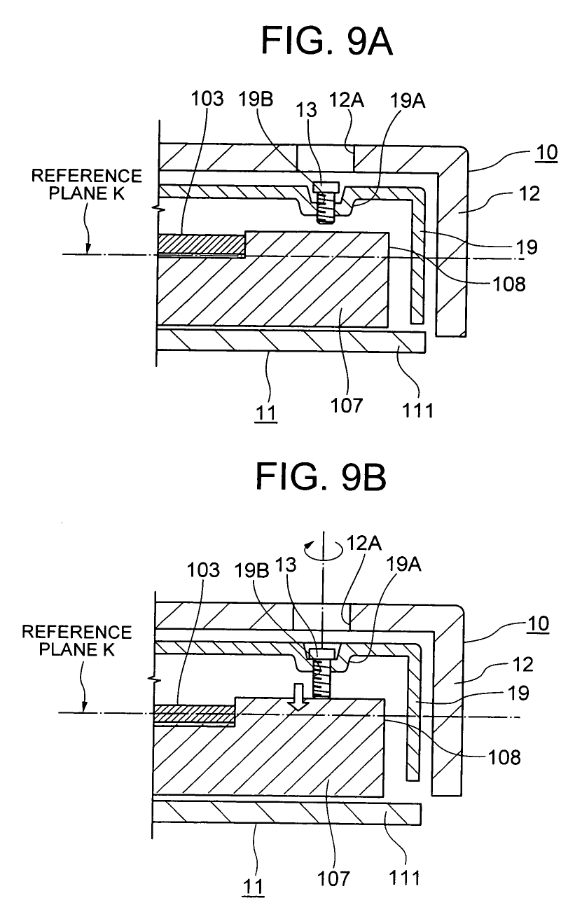

The adjusting action thereof will be described by referring to FIG. 8, FIG. 9A and FIG. 9B.

FIG. 8 shows a deformed state where the frame-type chassis 107 is twisted, and the A part and the C part in the four corners thereof are displaced towards the downward direction from the reference plane K.

In this case, the displacement towards the downward direction from the reference plane K cannot be brought back towards the upward direction with the first exemplary embodiment. Therefore, the A part, the B part, the C part, and the D part may all be aligned on the same plane by displacing the B part and the C part on the reference plane K towards the downward direction of the reference plane K.

That is, first, the adjuster screws 13 are screwed in from the state of FIG. 9A towards the downward direction, i.e. towards the panel holding frame 108 side and, as shown in FIG. 9B, the adjuster screws 13 are screwed in further. Upon this, the tips of the screws 13 push the top face of the panel holding frames 108. As a result, the panel holding frames 108 as well as the A part and the C part of the frame-type chassis 107 can be displaced towards the downward direction with respect to the reference plane K.

At last, the A part, the B part, the C part, and the D part may all be aligned on the position of the reference plane K, so that the displacement can be adjusted.

As described above, when adjusting the displacement by the adjuster screws 13, the adjuster screws 13 are screwed in and adjusted to the optimum positions while checking the state of the unevenness S by actually driving the screen.

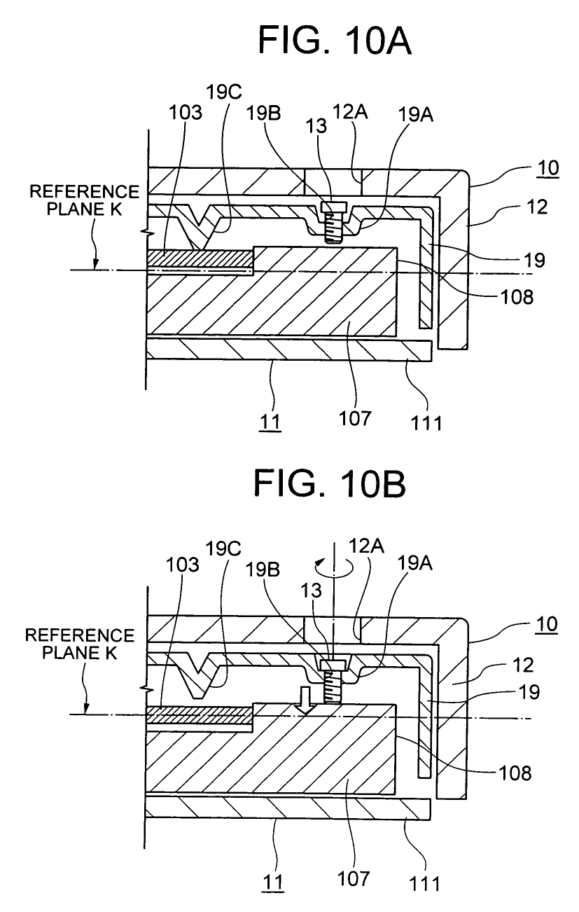

Further, it is also possible to adjust the displacement when the shield plate 19 comes in contact with the liquid crystal panel 103 and displaces the liquid crystal panel 103 in a pushing direction because of a deformation in the opening part of the shield part 19. Next, the adjusting action thereof will be described by referring to FIG. 10A and FIG. 10B.

FIG. 10A is an illustration for showing a state where a part 19C of the shield plate 19 is deformed, and the part 19C comes in contact with the surface of the liquid crystal panel 103. In this case, the liquid crystal panel 103 is deformed partially towards the downward direction with respect to the reference plane K, having the above-described contact part 19C as the origin.

In order to adjust such displacement, the reference plane K may be moved towards the downward direction for the amount of the displacement generated because the deformed part 19C of the shield part 19 is in contact with the liquid crystal panel 103. Thereby, the positions of the panel holding frames 108 at the A part to D part are aligned to a new reference plane K, so that the displacement of the liquid crystal panel 103 generated by the deformed part 19C can be solved.

That is, as shown in FIG. 10B, the adjuster screw 13 is screwed into all the four points at the A part to D part in the four corners of the frame-type chassis 107 in order, so as to displace the panel holding frames 108 towards the downward direction from the reference plane K for the amount of the displacement.

Practically, as described above, the adjustment work is performed through adjusting the A part to the D part little by little by searching the position at which the unevenness S becomes unrecognizable, while checking the display on the screen of the liquid crystal panel 103.

Further, even if there is no such assembling distortion remained after the liquid crystal module is completed, when the liquid crystal panel 103 is deformed in accordance with an irregular deformation that may be caused because of a difference in the distributions of the temperatures generated by the heat of the lamp when it is lighted up or because of differences in the thermal expansion of the structural components generated due to a change in the surrounding temperature and humidity, it is possible to correct the deformation to be in the optimum state by driving the adjuster screws 13 in the direction with which the deformation can be corrected. With this, the display unevenness S can be eliminated or reduced easily within a short time.

With the first exemplary embodiment having the above-described structure, following effects can be obtained.

(1) In the liquid crystal module 11 and the liquid crystal display device 10 of the exemplary embodiment, the burring 19A is formed at two points each in the four corners of the shield plate 19, and the adjuster screw 13 is screwed in the screw hole 19B of the burring 19A. Thus, by pressing the panel holding frames 108 through screwing the adjuster screws 13 into the screw holes 19B, height of the panel holding frames 108 and the frame-type chassis 107 can be adjusted. As a result, even when the liquid crystal panel 103 is deformed in the twisted direction due to small size differences which are occurred during the time of processing or assembling of the frame-type chassis 107 and any of the parts in the four corners becomes higher or lower than the reference plane K as a level face, the deformed position can be aligned with the reference plane K by pressing a prescribed part in the four corners of the panel holding frame 108. As a result, the unevenness S in the display of the screen generated from the distortion stresses generated during the time of processing or assembling can be eliminated or reduced easily within a short time.

(2) As described above, the height of the panel holding frames 108 and the frame-type chassis 107 can be adjusted by the adjuster screws 13. Therefore, even when there is distortion generated in the frame-type chassis 107 in the direction for twisting the liquid crystal panel 103 in accordance with the assembling distortion that is generated due to the small size differences of the components when mounting the lamp and the light guide plate so that any of the parts in the four corners become higher or lower than the reference plane K as the level face, the deformation can be corrected. With this, the display unevenness S can be eliminated or reduced easily within a short time.

(3) The height of the panel holding frames 108 and the frame-type chassis 107 can be adjusted by the adjuster screws 13. Therefore, even when there is deformation generated in the frame-type chassis 107 in the direction for twisting the liquid crystal panel 103 in accordance with the assembling distortion generated due to differences in the positions of the screws, fittings, the nails or the like for fixing the shield plate 19 so that any of the parts in the four corners become higher or lower than the reference plane K as the level face, the deformation can be corrected. With this, the display unevenness S can be eliminated or reduced easily within a short time.

(4) The height of the panel holding frames 108 and the frame-type chassis 107 can be adjusted by the adjuster screws 13. Therefore, even when there is deformation generated in the frame-type chassis 107 in the direction for twisting the liquid crystal panel 103 in accordance with the assembling distortion remained after completing the liquid crystal module due to multiple factors so that any of the parts in the four corners become higher or lower than the reference plane K as the level face, the deformation can be corrected. With this, the display unevenness S can be eliminated or reduced easily within a short time.

(5) The height of the panel holding frames 108 and the frame-type chassis 107 can be adjusted by the adjuster screws 13. Therefore, even when the liquid crystal panel 103 is deformed in the twisted direction in accordance with the assembling distortion generated due to differences in the positions of the fixing screws used for mounting the completed liquid crystal module to the device so that any of the parts in the four corners become higher or lower than the reference plane K as the level face, the deformation can be corrected. With this, the display unevenness S can be eliminated or reduced easily within a short time.

The height of the panel holding frames 108 and the frame-type chassis 107 can be adjusted by the adjuster screws 13. Therefore, even when there is the deformed part 19A in a part of the shield plate 19 and the deformed part 19A comes in contact with the surface of the liquid crystal panel 103 so that deformation is generated in the liquid crystal panel 103 by being pushed down from the contact part as the origin, it is possible to correct the deformation through pressing down the panel holding frame 108 by screwing in the adjuster screw 13. With this, the display unevenness S can be eliminated or reduced easily within a short time.

(7) There are two each of (a total of eight) screw holes provided in the four corners of the shield plate 19, and the adjuster screw 13 that optimally corresponds to the deformed part may be operated among those screws. As a result, the fine adjustment can be performed. This makes it possible to eliminate or reduce the display unevenness on the screen easily within a short time with still higher precision.

(8) With the liquid crystal display device 10 according to this exemplary embodiment, it is possible to adjust displacements while checking the display by actually driving the screen at the time of adjusting works performed for correcting the deformations of the liquid crystal panel 103 generated due to various factors. Therefore, even after being assembled as the module 11, the adjusting works can be performed easily by checking the state with the eyes. As a result, it provides such an effect that the displacement can be adjusted without any special skills.

(9) In the liquid crystal display device 10 according to this exemplary embodiment, the tool inserting holes 12A are opened on the surface of the front-side device casing 12. Thus, the adjuster screws 13 can be turned to be tightened or loosened by inserting a fastening tool such as a driver from the tool inserting holes 12A. Therefore, it is possible to perform an adjusting work of the deformation of the liquid crystal panel 103 even after it has become a completed product. This makes it possible to perform adjustment even in cases where the liquid crystal modules 11 are assembled into the liquid crystal devices 10 at a different device manufacturer. As a result, it becomes unnecessary to return the deformed module to the manufacturer thereof and disassemble it to perform readjustment.

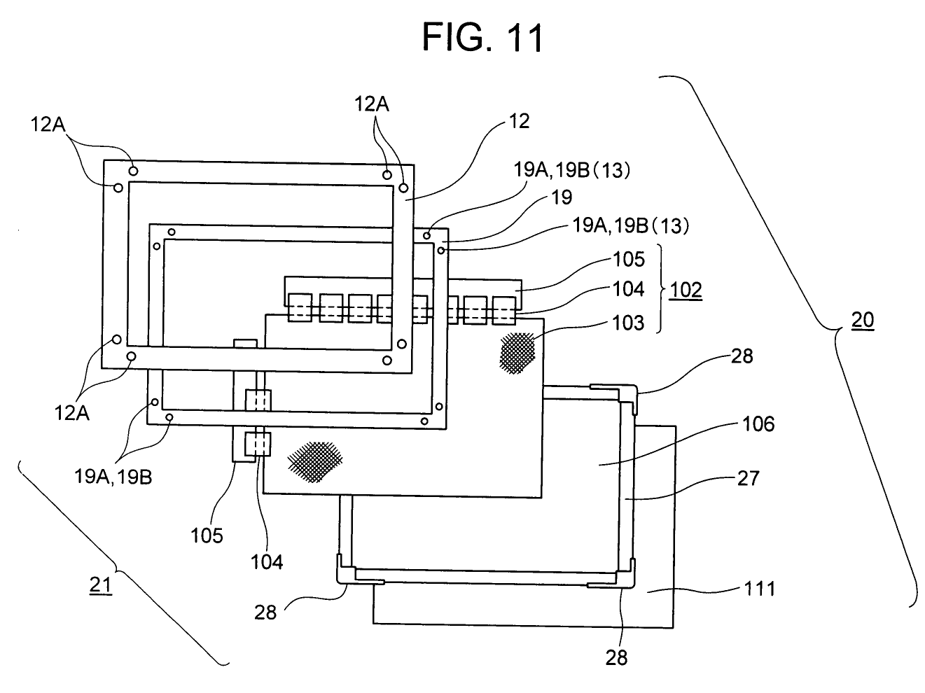

Next, a second exemplary embodiment of the invention will be described by referring to FIG. 11-FIGS. 13A and 13B.

A liquid crystal module 21 of a liquid crystal display device 20 according to the second exemplary embodiment includes a frame-type chassis 27 and panel holding frames 28, which are formed with a material different from each other. The height positions of the frame-type chassis 27 and the panel holding frames 28 are moved vertically for adjustment by using the adjuster screws 13 and elasticity of the materials.

The frame-type chassis 27 is made of a plate metal, while the panel holding frames 28 are resin-molded. The panel holding frames 28 are attached to the frame-type chassis 27.

The liquid crystal module 21 includes the panel unit 102, and the panel unit 102 is enclosed within the panel holding frames 28.

The shield plate 19 is covered over the panel unit 102 and fixed thereto, thereby completing the liquid crystal module 21.

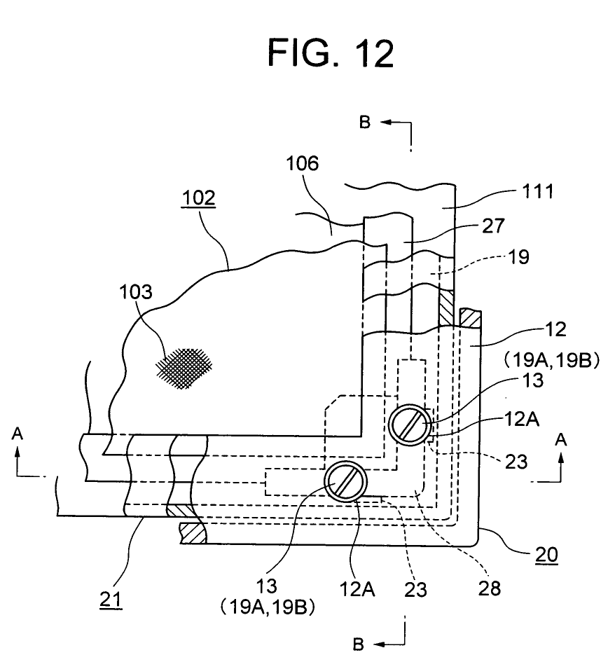

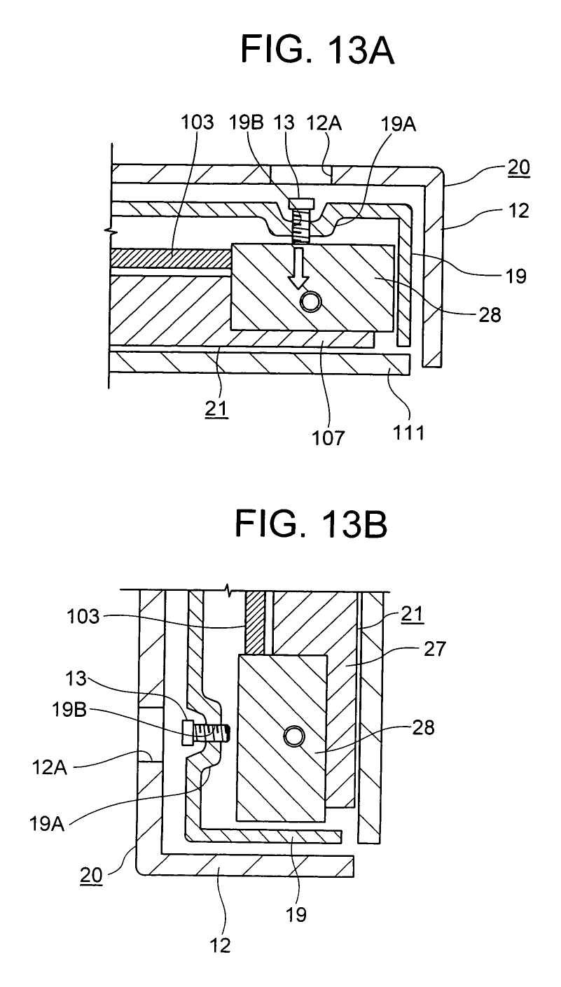

As shown in FIG. 12, FIG. 13A, and FIG. 13B, the shield plate 19 is formed in a size so that it is enclosed inside the front-side device casing 12. The liquid crystal module 21 is enclosed between the front-side device casing 12 and the back-side device casing 111, thereby forming the liquid crystal display device 20.

The panel holding frame 28 is formed substantially in an L-shaped side wall with a square part in its center part, when viewed two-dimensionally. Further, as shown in FIG. 11 and FIG. 12, the panel holding frame 28 is fixed in the four corners of the frame-type chassis 27. That is, holes (not shown) for inserting frame-fixing screws 23 are opened in the side faces (orthogonal to each other) of the panel holding frame 28, and screw holes (not shown) are provided in the side faces of the frame-type chassis 27 in the areas corresponding to the positions of the holes for inserting the frame-fixing screws 23.

Therefore, by pressing the inner sides of the side faces of the L-shapes of the panel holding frames 28 to the side faces in the four corners of the frame-type chassis 27, and screwing the frame-fixing screws 23 as frame-fixing members into the screw holes in the side faces of the frame-type chassis 27, the panel holding frames 28 can be fixed to the side faces in the four corners of the frame-type chassis 27.

The square part of the panel holding frame 28 allows the corner part of the liquid crystal panel 103 to be pressurized effectively.

In the second exemplary embodiment described above, the same actions as each of those described in the first exemplary embodiment by referring to FIG. 6-FIGS. 10A and 10B can be performed. As a result, in addition to achieving the same effects as those described in (1)-(9), a following effect can also be obtained as well.

(10) When the frame-type chassis 27 and the panel holding frames 28 are formed with the same material as in the case of the first exemplary embodiment, the shape obtained thereby becomes complicated. Thus, when using a mold, the structure of the mold becomes complicated, thereby increasing the cost. In the second exemplary embodiment, however, the frame-type chassis 27 and the panel holding frames 28 are formed with different materials. Thus, it is easy to manufacture each of those components, so that the manufacturing cost thereof can be reduced.

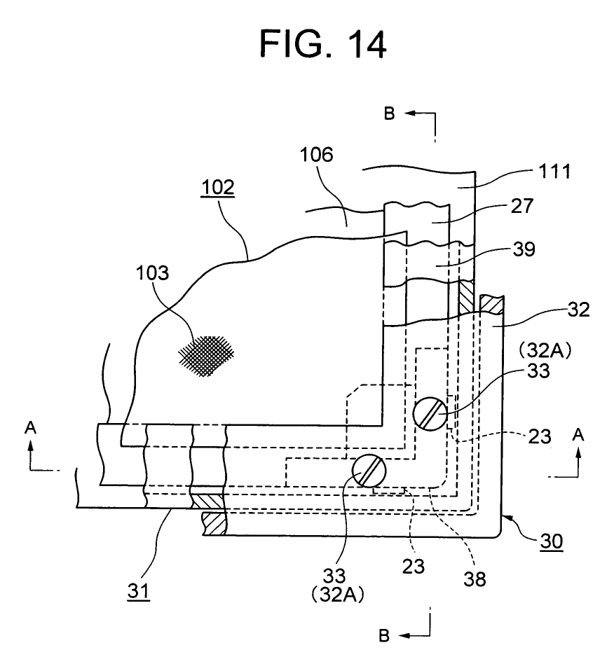

Next, a third exemplary embodiment of the present invention will be described by referring to FIG. 14-FIGS. 17A and 17B. The third exemplary embodiment is different from the first and second exemplary embodiments in respect that adjuster screws 33 are to be screwed into screw holes 38A that are formed in panel holding frames 38 in the third exemplary embodiment. However, the overall structure thereof is substantially same as the one described in the second exemplary embodiment by referring to FIG. 11. Therefore, an illustration of the overall structure will be omitted.

A liquid crystal module 31 in a liquid crystal display device 30 according to the third exemplary embodiment includes the frame-type chassis 27, the panel holding frames 38, and a shield plate 39. The third exemplary embodiment is so structured that it becomes also possible to adjust the displacement in a direction pulling up the chassis and the frames from the position of the reference plane K, whereas the first and second exemplary embodiments are capable of adjust the displacement only in a direction pushing down the chassis and the frames from the position of the reference plane K by the vertical movement of the adjuster screws 13.

That is, in the liquid crystal display device 30 of the third exemplary embodiment, a screw hole 38A is provided in the panel holding frame 38 at a contact part between the adjuster screw 33 and the panel holding frame 38, and a screw inserting hole 39A is opened in the shield plate 39.

This screw inserting hole 39A is what is called an unloaded hole into which the screw part of an adjuster screw 22 is inserted and turned idle.

The liquid crystal module 31 includes the panel unit 102, and the panel unit 102 is enclosed within the panel holding frames 38.

The shield plate 39 is covered over the panel unit 102 and fixed thereto, thereby completing the liquid crystal module 31.

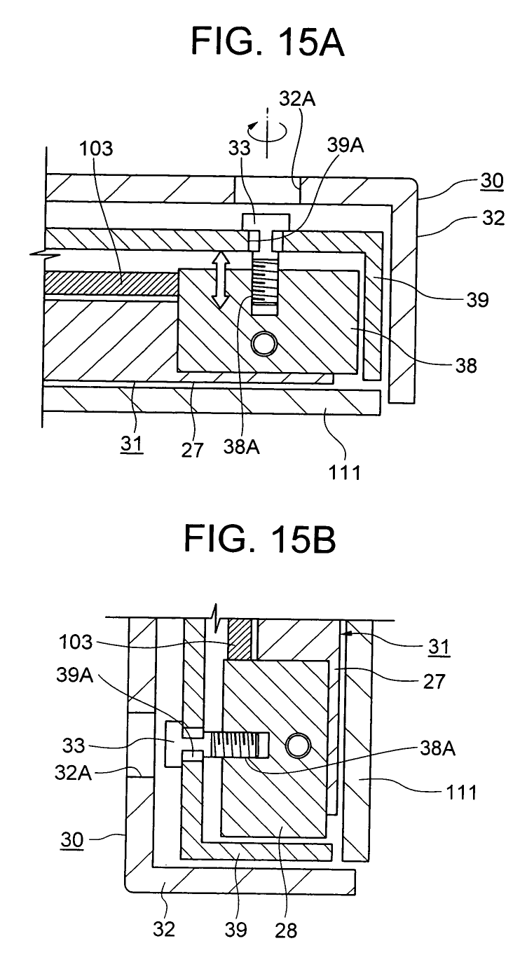

As shown in FIG. 15A and FIG. 15B, the shield plate 39 is formed in a size so that it is enclosed inside a front-side device casing 32. The liquid crystal module 31 is enclosed between the front-side device casing 32 and the back-side device casing 111, thereby forming the liquid crystal display device 30.

As described above, the screw inserting holes 39A illustrated respectively in FIG. 15A and FIG. 15B are provided at the positions shown in FIG. 14 in the four corners of the surface of the shield plate 39. Thereby, a total of eight screw inserting holes 39A are provided to the shield plate 39. The adjuster screw 33 is to be inserted into each of the screw inserting holes 39A.

The adjuster screw 33 has a different shape from that of the adjuster screw 13 used in the first and second exemplary embodiments. That is, a lower part of the screw head of the adjuster screw 33 is formed thin, so that it runs idle inside the screw inserting hole 39A.

Further, the screw hole 38A is formed in the upper part of the L-shaped wall of the panel holding frame 38, so that the adjuster screw 33 can be screwed into the screw hole 38A.

Therefore, when the adjuster screw 33 is screwed in, the panel holding frame 38 and the frame-type chassis 27 are pulled up towards the upward direction because the adjuster screw 33 is screwed into the screw hole 38A.

Inversely, when the adjuster screw 33 is loosened, the panel holding frame 38, the frame-type chassis 27, and the liquid crystal panel 103 can be pressurized towards the downward direction to be displaced.

Further, on the surface of the front-side device casing 32, a tool inserting hole 32A is opened at a position that corresponds to the adjuster screw 33. A tip of a fastening tool such as a driver is to be inserted into the tool inserting hole 32A, and it is possible to control the amount of displacement by inserting the fastening tool and turning the adjuster screw 33 to fasten or loosen it.

The amount of displacement is assumed to be within one (1) mm. However, this exemplary embodiment can also be applied when the amount of the displacement is over one (1) mm.

Next, operations of the third exemplary embodiment will be described.

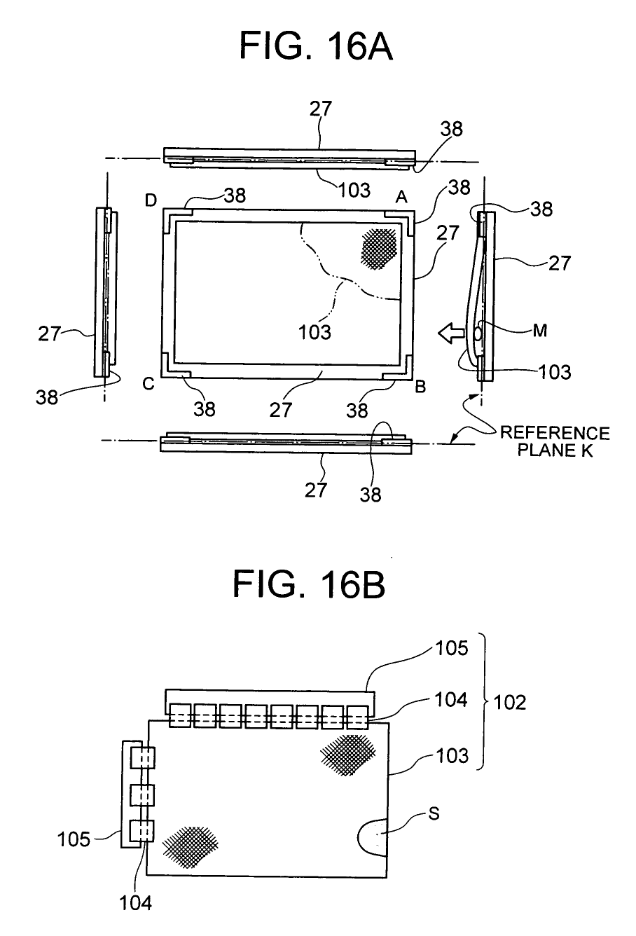

The third exemplary embodiment is capable of adjusting displacement that is caused when a foreign matter M enters between the liquid crystal panel 103 and the frame-type chassis 27, as shown in FIG. 16A and FIG. 16B.

That is, FIG. 16A shows a schematic view showing a state where there is the foreign matter M between the liquid crystal panel 103 and the frame-type chassis 27 in the vicinity of the B part of the four corners of the frame-type chassis 27, and only this part is displaced in a direction of pushing up the liquid crystal panel 103. In this case, as shown in FIG. 16B, displacement like a circular-arc white broken line appears on the screen of the liquid crystal panel 103, and this displacement is displayed as unevenness S.

In such case, the reference plane K is moved towards the upward direction for the height of the foreign matter M so as to reset the reference plane K, and the four corners of the frame-type chassis 27, i.e. the positions of the A part to the D part of the panel holding frames 38, are aligned with the reset reference plane K. With this, displacement of the liquid crystal panel 103 caused due to the foreign matter M can be solved.

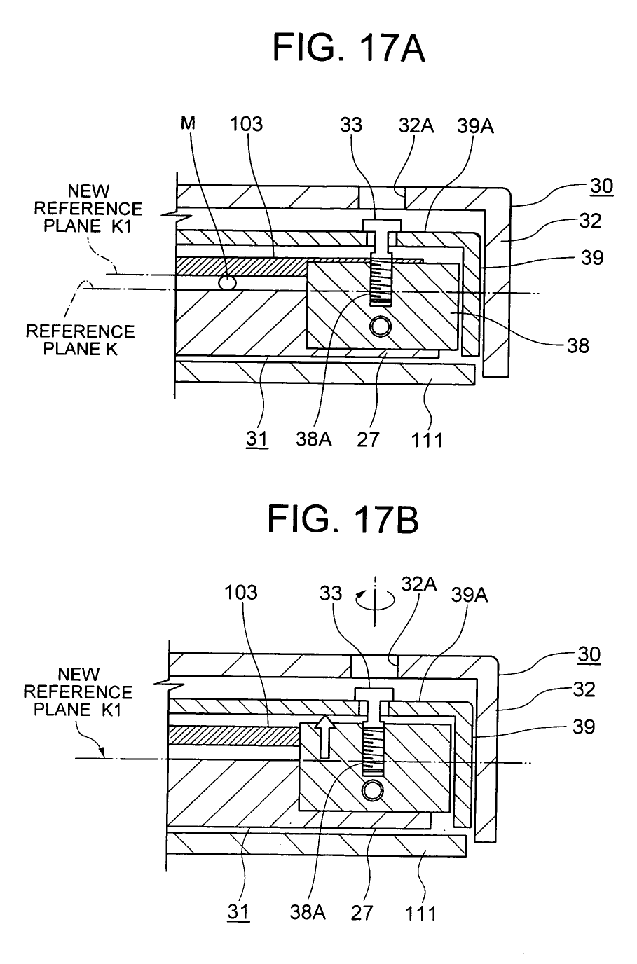

The adjuster screws 33 are screwed in at all of the four points of the A part to the D part so as to pull up and displace, from the state shown in FIG. 17A to the state shown in FIG. 17B, the panel holding frames 38 and the frame-type chassis 27 towards the upward direction for the height of the foreign matter M from the reference plane K.

Practically, the adjustment work is performed through adjusting the A part to the D part little by little by searching the position at which the unevenness S becomes unrecognizable, while checking the display on the screen of the liquid crystal panel 103.

With the third exemplary embodiment described above, a following effect can also be obtained in addition to achieving the same effects as those described in (6)-(9).

(10) That is, it is possible to pull up the panel holding frames 38 and the frame-type chassis 27 to adjust the height thereof by using the adjuster screws 33. As a result, when the foreign matter M enters between the liquid crystal panel 103 and the frame-type chassis 27 and deformation is generated in the liquid crystal panel 103 to push it up by having the foreign matter M as the origin, the deformation can be corrected by inserting the adjuster screws 33 and pulling up the panel holding frames 38 and the frame-type chassis 27 for the height of the foreign matter M. With this, the display unevenness S caused due to the foreign matter M can be eliminated or reduced easily within a short time.

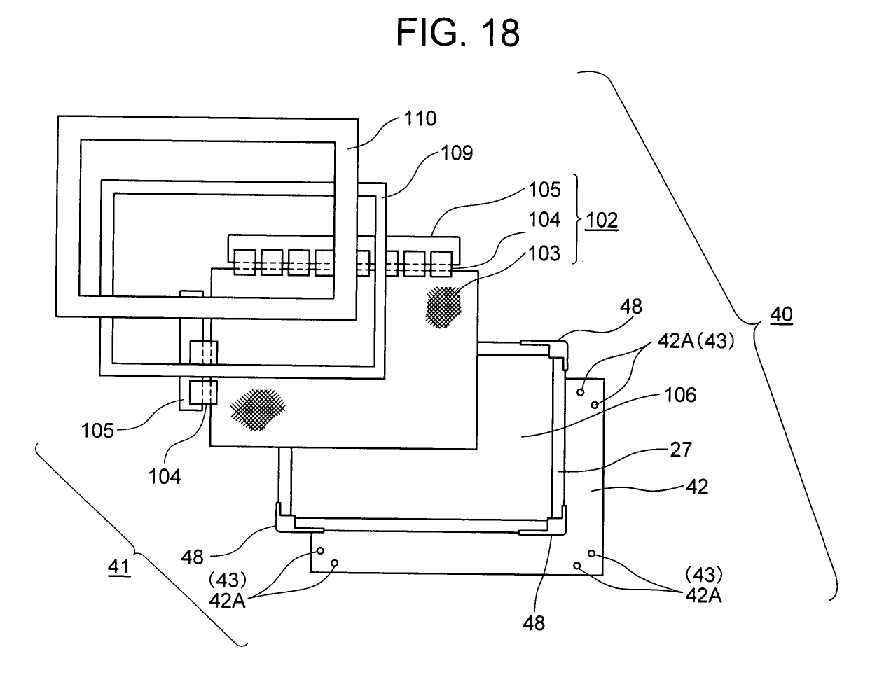

Next, a fourth exemplary embodiment of the present invention will be described by referring to FIG. 18-FIGS. 20A and 20B.

A liquid crystal display device 40 according to the fourth exemplary embodiment is formed to be capable of adjusting displacement of the frame-type chassis 27 and the panel holding frames 48 in the vertical directions (directions approaching and isolating to/from the screen of the liquid crystal panel) from the back side of the liquid crystal display device 40.

That is, a liquid crystal module 41 of the liquid crystal display device 40 according to the fourth exemplary embodiment includes the frame-type chassis 27 and the panel holding frames 48. The height positions of the frame-type chassis 27 and the panel holding frames 48 are moved vertically for adjustment through the adjuster screws 43 that are the displacement adjusting members.

The liquid crystal module 41 includes the panel unit 102, and the panel unit 102 is enclosed within the panel holding frames 48.

The shield plate 109 is covered over the panel unit 102 and fixed thereto, thereby completing the liquid crystal module 41.

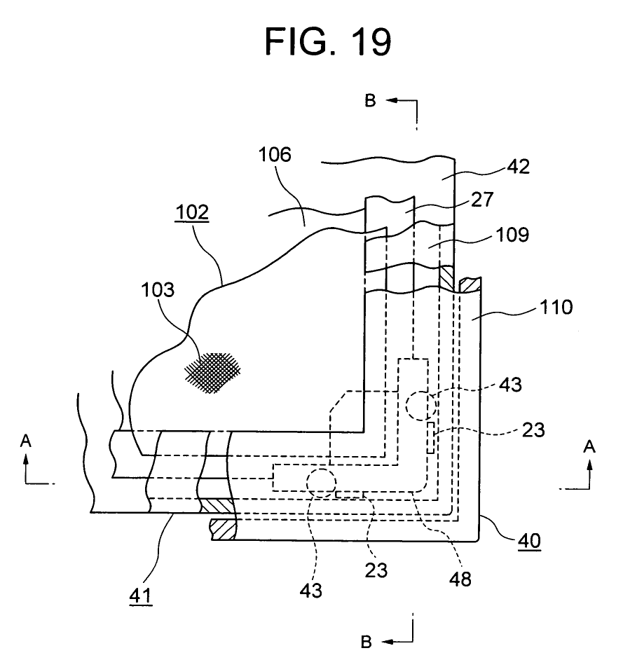

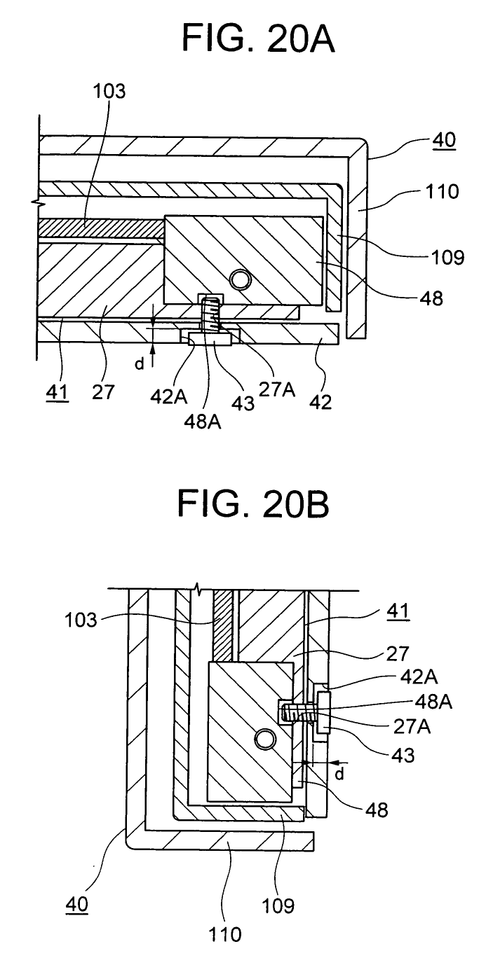

As shown in FIG. 19, FIG. 20A, and FIG. 20B, the shield plate 109 is formed in a size so that it is enclosed inside the front-side device casing 110. The liquid crystal module 41 is enclosed between the front-side device casing 110 and a back-side device casing 42, thereby forming the liquid crystal display device 40.

In the liquid crystal display device 40, the panel holding frames 48 are attached to the four corners of the frame-type chassis 27 with the frame fixing screws 23. In the liquid crystal module 41, screw holes (not shown) for being mounted to the front-side device casing 110 are provided in the four corners of the shield plate 109, and the shield plate 109 is fixed to the front-side device casing 110 with the frame fixing screws 23.

In the back faces of the four corners of the back-side device casing 42, screw attaching holes 42A are opened at positions that correspond to the areas of the panel holding frames 48, which are extruded from the external shape of the frame-type chassis 27. The adjuster screws 43 as the displacement adjusting members can be inserted into the screw attaching holes 42A.

In the meantime, screw holes 27A into which the adjuster screws 43 are screwed upwardly are formed in the back face of the frame-type chassis 27.

In the back face of the panel holding frame 48, there is formed a relief hole 48A that connects to the screw hole 27A of the frame-type chassis 27 and serves as a relief part for the tip of the adjuster screw 43.

The screw attaching hole 42A is formed with a large-diameter part to which the head of the adjuster screw 43 is inserted, and a small-diameter part that is continued from the large-diameter part, to which the screw part of the adjuster screw 43 is inserted. Depth d of the large-diameter part is set in such a size that displacement can be adjusted by screwing the adjuster screw 43 therein and vertically moving the panel holding frames 48 and the frame-type chassis 27. Specifically, since the amount of displacement in the exemplary embodiments is assumed to be within one (1) mm, the depth d is set to be in a size that is obtained by adding about 1.5 mm to the height of the head part of the adjuster screw 43.

Therefore, when the adjuster screw 43 is screwed into the screw hole 27A from the screw attaching hole 42A and turned to be screwed in by a tool such as a driver, the tip of the adjuster screw 43 pushes up the bottom part of the screw hole 27A because the adjuster screw 43 is screwed into the screw hole 27A of the frame-type chassis 27. With this, the panel holding frame 48 and the frame-type chassis 27 are pushed up. As a result, the panel holding frames 48 and the frame-type chassis 27 can be displaced towards the upwards direction.

Further, when the adjuster screw 43 is turned inversely to loosen the engagement between the adjuster screw 43 and the screw hole 27A of the frame-type chassis 27, the panel holding frames 48 and the frame-type chassis 27 return to the original positions due to the rigidity of the frame-type chassis 27.

The amount of displacement is assumed to be within one (1) mm. However, this exemplary embodiment can also be applied when the amount of the displacement is over one (1) mm.

In the fourth exemplary embodiment as described above, the panel holding frames 48 and the frame-type chassis 27 are pushed up by screwing in the adjuster screws 43. Thus, it is possible to achieve the same effects as those of the third exemplary embodiment. Further, it is also possible to achieve the same effects as those described in (6)-(9) and (11).

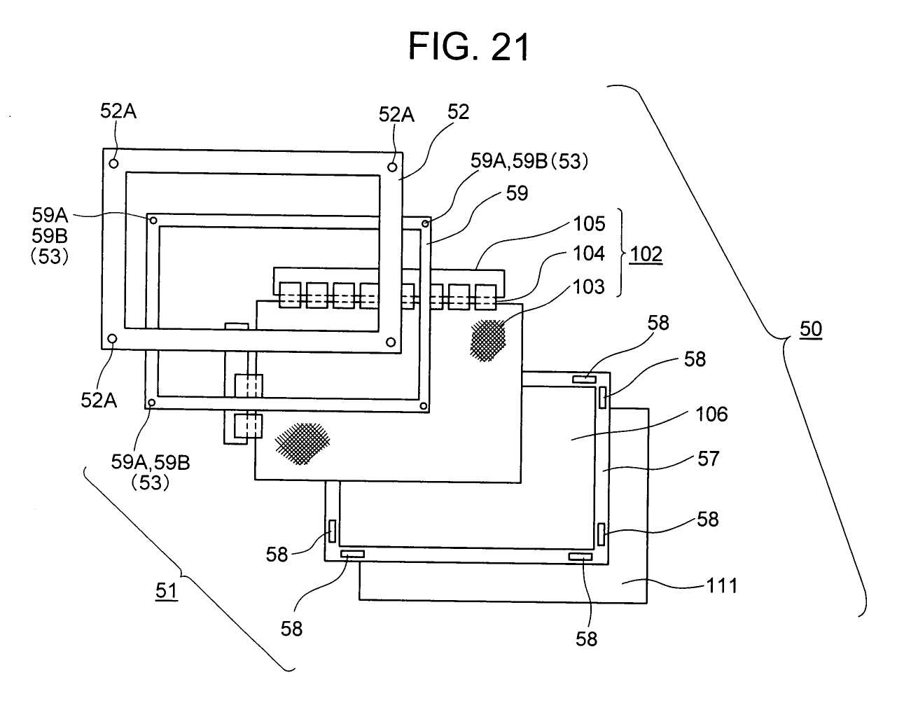

Next, a fifth exemplary embodiment of the present invention will be described by referring to FIG. 21-FIGS. 23A and 23B.

In a liquid crystal display device 50 of the fifth exemplary embodiment, the number of total adjuster screws is reduced to four, whereas there are a total of eight adjuster screws 13, 23, 33, or 43 provided respectively in the first to fourth exemplary embodiments.

That is, a liquid crystal module 51 of the liquid crystal display device 50 according to the fifth exemplary embodiment includes a frame-type chassis 57 and panel holding frames 58. The height positions of the frame-type chassis 57 and the panel holding frames 58 are moved vertically for adjustment through a total of four adjuster screws 53 that are the displacement adjusting members.

The frame-type chassis 57 and the panel holding frames 58 are resin-molded as one body.

Further, the panel holding frame 58 is formed in an L-shape with a missing corner when viewed two-dimensionally.

The liquid crystal module 51 includes the panel unit 102, and the panel unit 102 is enclosed within the panel holding frames 58.

A shield plate 59 is covered over the panel unit 102 and fixed thereto, thereby completing the liquid crystal module 51.

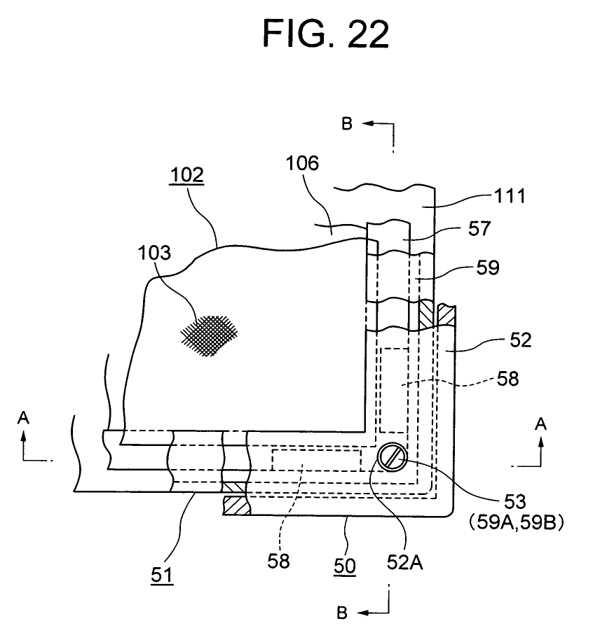

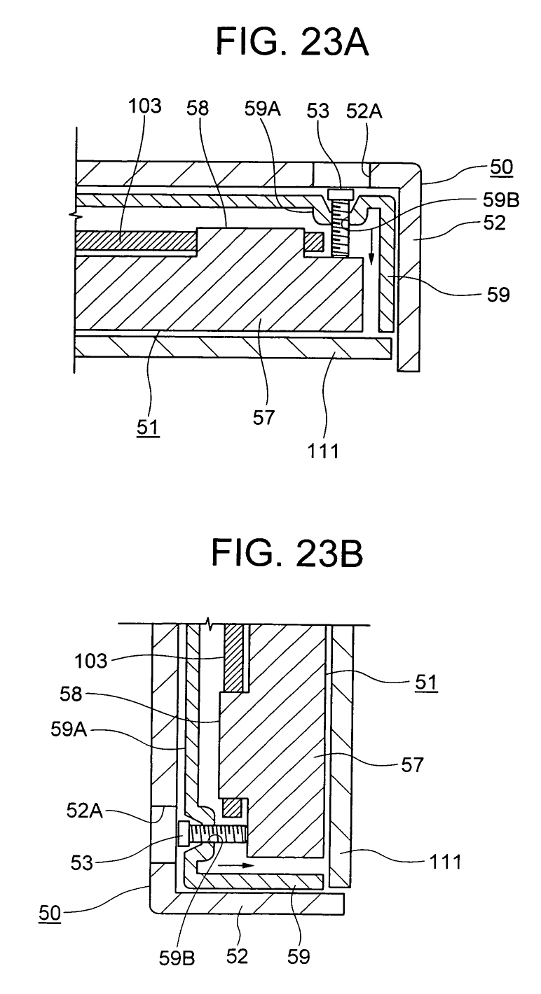

As shown in FIG. 22, FIG. 23A, and FIG. 23B, the shield plate 59 is formed in a size so that it is enclosed inside a front-side device casing 52. The liquid crystal module 51 is enclosed between the front-side device casing 52 and the back-side device casing 111, thereby forming the liquid crystal display device 50.

In the fifth exemplary embodiment, a burring 59A is formed in each of the four corners on the surface of the shield plate 59 as shown in FIG. 23A, so that there are a total of four burrings 59A provided on the shield plate 59. A screw hole 59B is opened in each burring 59A, and the adjuster screw 53 is fitted to the screw hole 59 to be screwed therein.

Such burring 59A is formed in a respective position in each of the four corners of the shield plate 59, which corresponds to the missing corner part of the panel holding frame 58.

Therefore, when the adjuster screw 53 is turned, the tip of the screw comes to be in contact with the top face of the frame-type chassis 57 in the missing part of the corner of the L-shape of the panel holding frame 58. When the adjuster screw 53 is screwed in further, the tip of the screw pushes the frame-type chassis 57, so that the panel holding frame 58 and the frame-type chassis 57 are displaced towards the downward direction.

In the meantime, when the adjuster screw 53 is turned inversely, the tip of the adjuster screw 53 is released from the top face of the frame-type chassis 57. As a result, the panel holding frame 58 and the frame-type chassis 57 return to the original positions because of the elasticity of the frame-type chassis 57.

The amount of displacement is assumed to be within one (1) mm. However, this exemplary embodiment can also be applied when the amount of the displacement is over one (1) mm.

As shown in FIG. 22, in the fifth exemplary embodiment, the panel holding frame 58 is formed in an L-shape with a missing corner part, and the adjuster screw 53 directly pushes the frame-type chassis 57 in the corner part of the L-shape. The four corners of the frame-type chassis 57 can be pressurized in more well-balanced manner with this structure. Thus, displacement can be more stably performed than the case of the first exemplary embodiment, for example, in which each of the top faces of the L-shaped corners in the four corners of the frame-type chassis 57 is pressurized by two adjuster screws 13.

When each of the top faces of the L-shaped corners in the four corners of the frame-type chassis 57 is pressurized by two adjuster screws 53, it is hard to balance between the two adjuster screws 53. Even if the two adjuster screws 53 in each of the four corners can be well balanced, it may be still difficult to adjust the balance delicately for the four corners as a whole.

In the front-side device casing 52, tool inserting holes 52A are opened at positions corresponding to the burrings 59A provided in the four corners of the surface of the shield plate 59. A tool such as a driver can be inserted from the tool inserting hole 52A to turn the adjuster screw 53.

With the fifth exemplary embodiment described above, following effects can be obtained in addition to achieving the same actions as those of the first to third exemplary embodiments and obtaining substantially the same effects of (1)-(9).

(12) The adjuster screw 53 directly pushes the frame-type chassis 57 in the corner part of the L-shape. The four corners of the frame-type chassis 57 can be pressurized in more well-balanced manner with this structure. Thus, displacement can be more stably performed than the case of the first exemplary embodiment, for example, in which each of the top faces of the L-shaped corners in the four corners of the frame-type chassis 57 is pressurized by two adjuster screws 53.

(13) There are a total of four adjuster screws 53 being attached, and the frame-type chassis 57 can be stably pushed with the four adjuster screws 53. Since the number of the adjuster screws can be reduced, there is required less time and effort for processing the burrings 59A of the shield plate 59 and for processing the tool inserting holes 52A of the front-side device casing 52. In addition, the consumed amount of the adjuster screws 53 can be reduced.

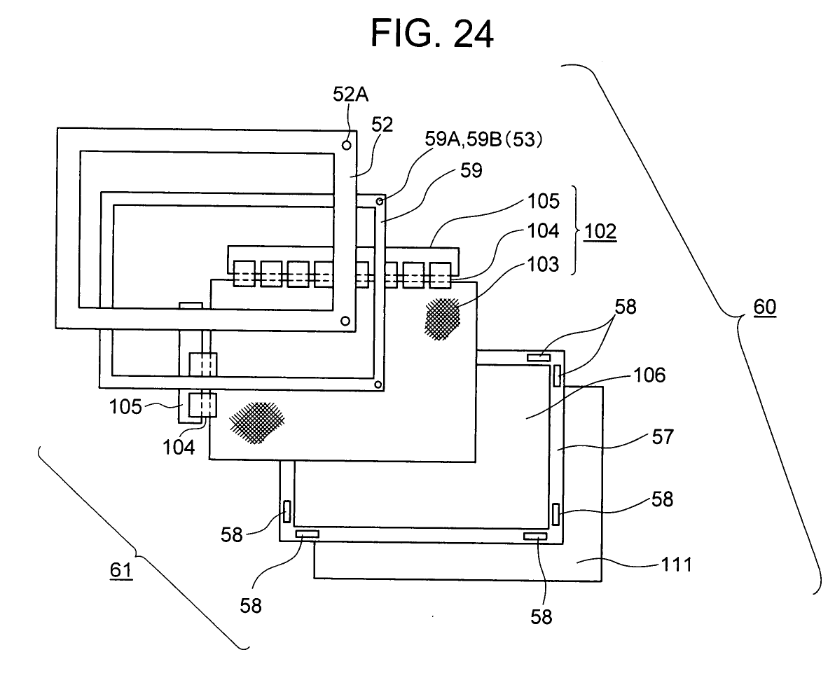

Next, a sixth exemplary embodiment of the present invention will be described by referring to FIG. 24.

A module 61 of a liquid crystal display device 60 according to the sixth exemplary embodiment uses two corners out of the four corners of the frame-type chassis 57 and panel holding frame 58 as displacement adjusting areas.

In the liquid crystal module 61 of the liquid crystal display device 60, screw holes (not shown) are provided to the side face of a shield plate 69 for being attached to the front-side device casing 52. Through the holes, it is fixed to the front-side device casing 52 with the frame fixing screws 23.

The liquid crystal display device 60 of the sixth exemplary embodiment has basically the same structure as that of the liquid crystal display device 50 of the fifth exemplary embodiment, except that the liquid crystal display device 60 uses two corners among the four corners of the frame-type chassis 57 and the panel holding frame 58 for adjusting the displacement. The operations thereof are substantially the same as well.

That is, the burring 59A is provided in each corner part of the two corners of the shield plate 59, so that the adjuster screws 53 can be mounted to the screw hole of the burring 59A. Further, tool inserting holes 52A are opened in the front-side device casing 52 at the positions corresponding to the burrings 59A.

Therefore, when the adjuster screw 53 is turned, the tip of the screw comes to be in contact with the top face of the frame-type chassis 57 in the corner part of the L-shape of the panel holding frame 58.

Then, when the adjuster screw 53 is screwed in further, the tip of the screw pushes down the frame-type chassis 57, so that the frame-type chassis 57 is displaced towards the downward direction.

In the meantime, when the adjuster screw 53 is turned inversely, the frame-type chassis 57 returns to the original position because of the elasticity of the frame-type chassis 57.

The amount of displacement is assumed to be within one (1) mm. However, this exemplary embodiment can also be applied when the amount of the displacement is over one (1) mm.

As described above, in the sixth exemplary embodiment, the frame-type chassis 57 is directly pushed by the adjuster screws 53 as in the case of the fifth exemplary embodiment, so that the four corners of the frame-type chassis 57 can be pressurized in a well-balanced manner.

With the sixth exemplary embodiment described above, the same operations as those of the fifth exemplary embodiment can be performed. Further, it is possible with the sixth exemplary embodiment to obtain following effects in addition to achieving the same effects as those of the fifth exemplary embodiment.

(14) Among the four corners of the frame-type chassis 57 and the panel holding frame 58, the two corners are used for adjusting the displacement. Therefore, particularly when the areas corresponding to the A part and the B part in the first exemplary embodiment, for example, are displaced towards the upward direction with respect to the reference plan K, those areas may be pressurized by the adjuster screws 53. Thus, when deformation is generated in the two corners, such deformation can be adjusted.

(15) Since the two corners are used for adjusting the displacement among the four corners of the frame-type chassis 57 and the panel holding frame 58, the number of the tool inserting holes 12A of the front-side device casing 12 and the screw holes 59 of the burrings 59A in the shield plate 59 can be reduced, so that the time and effort necessary for processing those can be reduced. Further, it also provides such an effect that the number of adjuster screws 53 to be screwed into the screw holes 59B can be reduced.

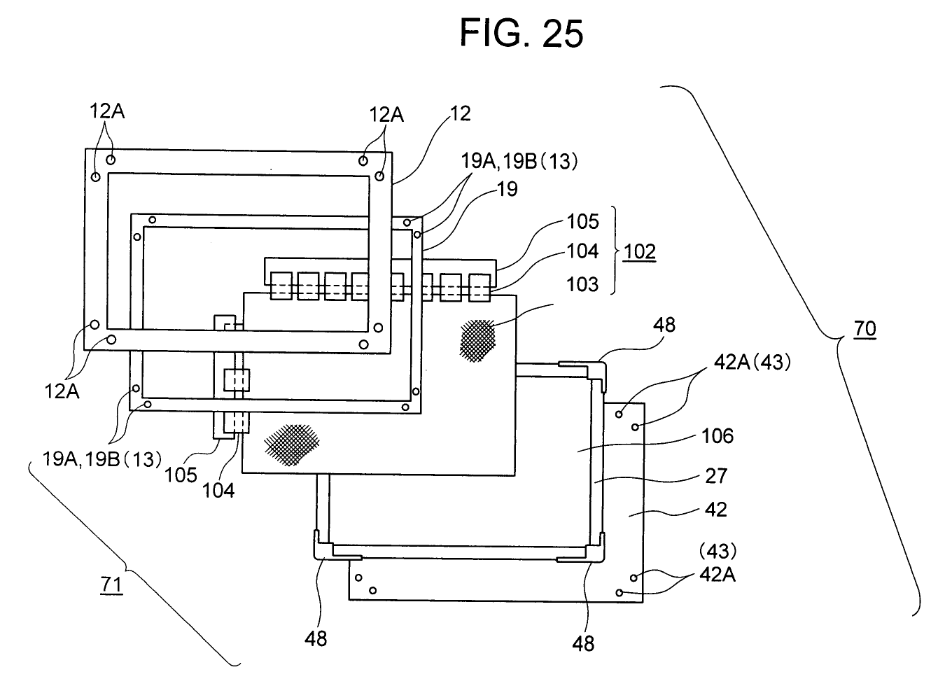

Next, a seventh exemplary embodiment of the present invention will be described by referring to FIG. 25-FIGS. 27A and 27B.

A liquid crystal display device 70 of the seventh exemplary embodiment has a structure that is a combination of the second and fourth exemplary embodiments, in which displacement of the panel holding frames 48 and the frame-type chassis 27 is adjusted by both the set screw (screw pressing from the above; adjuster screw 13) and a drawing screw (screw drawn towards the downwards direction when pressed with the set screw; adjuster screw 43). This exemplary embodiment is used when highly precise adjustment is required.

That is, in a module 71 of the liquid crystal display device 70, the burring 19A is provided at two positions each in the four corners of the shield plate 19, so that the adjuster screws 13 can be mounted to the screw hole 19B of the burring 19A. Further, tool inserting holes 12A are opened in the front-side device casing 12 at the positions corresponding to the burrings 19A.

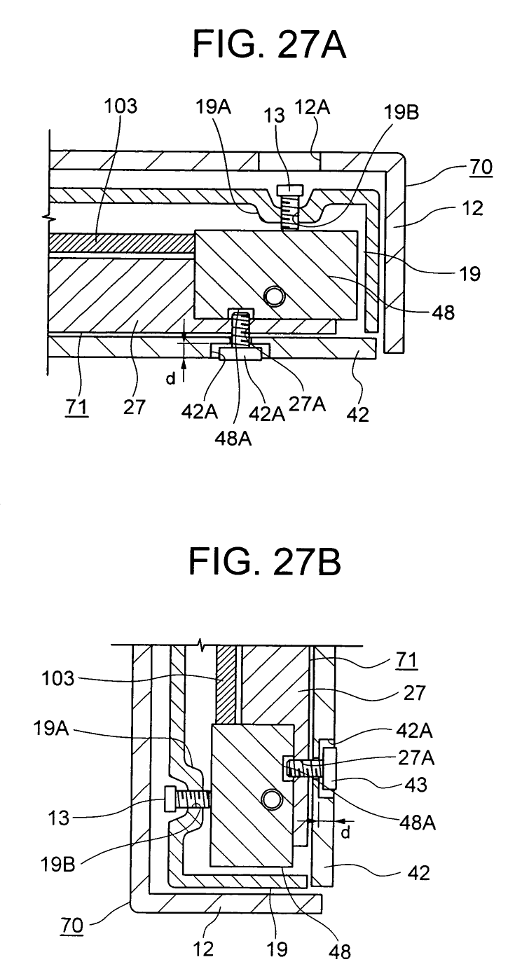

Thus, a tool such as a driver is inserted from the tool inserting hole 12A to turn the adjuster screw 13. Upon this, as shown in FIG. 27A, the tip of the screw comes in contact with the top face of an L-shaped wall of the panel holding frame 48. As shown in FIG. 27B, by further screwing the adjuster screw 13 into the tool inserting hole 12A, the panel holding frame 48 and the frame-type chassis 27 can be displaced towards the downward direction. This adjuster screw 13 configures the set screw to set (to screw in) the frame-type chassis 27 and the like.

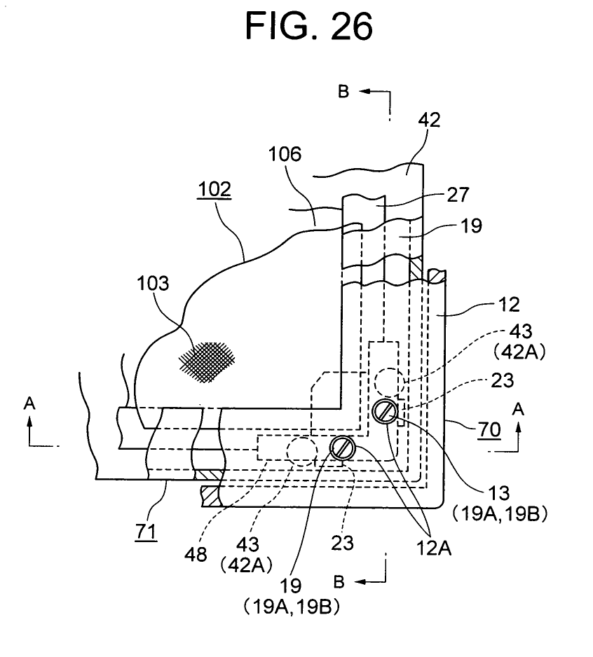

As shown in FIG. 26, the panel holding frames 48 are fixed to the four corners of the frame-type chassis 27 with the frame fixing screws 23. Holes (not shows) for inserting the frame fixing screws 23 are opened in the side faces of the panel holding frames 48, and screw holes (not shown) are provided in the side faces of the frame-type chassis 27 in the areas corresponding to those positions.

In the seventh exemplary embodiment, as shown in FIG. 26, FIG. 27A, and FIG. 27B, an adjuster screw 43 as the displacement adjusting member is mounted upwardly to a screw hole 42A of the back-side device casing 42 as in the case of the fourth exemplary embodiment, and the adjuster screw 43 is screwed into the screw hole 27A formed in the frame-type chassis 27. Through screwing in the adjuster screw 43, the frame-type chassis 27 and the panel holding frame 48 can be pushed up.

When screwing in the adjuster screw 13, the adjuster screw 43 is set back, i.e. it is drawn back. The adjuster screw 43 thereby configures the drawing screw.

In the back face of the panel holding frame 48, there is formed a relief hole 48A that connects to the screw hole 27A of the frame-type chassis 27 and serves as a relief part for the tip of the adjuster screw 43.

In the four corners of the shield plate 19, the screw holes 42A are opened at positions that correspond to the areas of the panel holding frames 48, which are extruded from the external shape of the frame-type chassis 27. The adjuster screw 43 is mounted to the screw hole 42A, and the adjuster screw 43 can be turned by a tool such as a driver.

Therefore, when the adjuster screw 43 is turned, the tip of the screw comes to be in contact with the bottom part of the relief hole 48A of the panel holding frame 48. When the adjuster screw 43 is screwed in further, the panel holding frame 48 and the frame-type chassis 27 can be displaced towards the upward direction.

The amount of displacement is assumed to be within one (1) mm. However, this exemplary embodiment can also be applied when the amount of the displacement is over one (1) mm.

With the seventh exemplary embodiment described above, the same operations as those of the second and fourth exemplary embodiments can be performed. Further, it is possible with the seventh exemplary embodiment to obtain following effects in addition to achieving the same effects as those of the second and fourth exemplary embodiments.

(16) When the adjuster screw 13 is pressurizing the panel holding frame 48, the adjuster screw 43 is set back. Meanwhile, when the adjuster screw 13 is fixed at a prescribed position, the adjuster screw 43 can be screwed in so as to pressurize the panel holding frame 48 from the back face side thereby to securely hold the panel holding frame 48 in that position. Therefore, after adjusting the displacement, the positions of the panel holding frame 48 and the frame-type chassis 27 can be maintained under a stable state. Thus, the seventh exemplary embodiment can be utilized for cases where highly precise adjustment is required, etc.

Note here that the present invention is not limited only to each of the exemplary embodiments described above. It is intended to include all possible modifications and improvements without departing from the scope of the appended claims with which the object of the present invention can be achieved.

For example, two each of the adjuster screws 13 or 33 are provided in the four corners of the shield plate 19 or 39 in the first to third exemplary embodiments described above. However, the present invention is not limited to that. One each of the adjuster screw may be provided in the four corners as in the case of the fifth exemplary embodiment.

Further, even though two each of the adjuster screws 43 are provided in the back faces of the four corners of the panel holding frame 48 in the fourth exemplary embodiment, one each of the adjuster screw 43 may be provided in the back faces of the four corners of the panel holding frame 48.

Furthermore, in the sixth exemplary embodiment, the adjuster screws 53 are provided at two positions on the right side in the short sides of the frame-type chassis 57 and the panel holding frames 58 to adjust displacement. However, the adjuster screws 53 may be provided on the left side, or may be provided at two positions on a diagonal line. Moreover, one each of the adjuster screw 53 is provided at the two positions in the sixth exemplary embodiment. However, two each of the adjuster screws 53 may be provided instead.

Next, other exemplary embodiments of the present invention will be described. The liquid crystal module may be structured in a following manner. That is, the displacement adjusting member is configured with a displacement adjusting screw; a screw hole is opened at least in one corner on a surface of the shield plate; the displacement adjusting screw is screwed into the screw hole; and a top face of either the frame-type chassis or the panel holding frame is pressurized by a tip of the displacement adjusting screw, whereby the frame-type chassis and the panel holding frame can be displaced.

With this structure, displacement generated either in the frame-type chassis or in the panel holding frame can be adjusted by engaging the displacement adjusting screw with the screw hole of the shield plate and screwing it in. Therefore, an adjusting work can be performed easily.

Further, the liquid crystal module may be structured in a following manner. That is, the panel holding frame is formed substantially in an L-shape when viewed two-dimensionally, and such panel holding frame is provided in four corners of the frame-type chassis; two each of the screw holes are opened in four corners of the surface of the shield plate in an areas corresponding to the panel holding frames; the displacement adjusting screw is screwed into each of the screw holes; and a top face of the panel holding frame is pressurized by tips of the displacement adjusting screws, whereby the panel holding frames can be displaced.

In this structure, two screw holes are opened in each of the four corners of the shield plate, and the displacement adjusting screw is screwed into each of the screw holes. Thus, even if the frame-type chassis and the panel holding frames are twisted and deformed in a prescribed direction so that a prescribed part becomes higher or lower than the liquid crystal panel, it is possible to correct the deformed part into a normal state by pressurizing the high part, etc. Further, there are two each of the screw holes provided in each of the four corners of the shield plate (total of eight screw holes) and the displacement adjusting screw is screwed into each of the screw holes. Thus, among those screws, the displacement adjusting screw at an area that best corresponds to the deformed part may simply be operated. As a result, fine adjustment of the displacement can be performed, so that unevenness of the screen display can be eliminated or reduced easily within a short time with still higher precision.

Furthermore, the liquid crystal module may be structured in a following manner. That is, two each of the screw holes are opened in four corners of the panel holding frame; screw inserting holes are opened in four corners on the surface of the shield plate by corresponding to the screw holes; the displacement adjusting screws are screwed into the screw inserting holes, and the displacement adjusting screws are screwed into the screw holes of the panel holding frame, whereby the panel holding frame can be displaced in a direction approaching to or isolating from the screen of the liquid crystal panel.

In this structure, the displacement adjusting screws are provided to two each of the screw holes which are opened in the four corners of the panel holding frame. Thus, the panel holding frame can be brought to a direction approaching to the shield plate, i.e. brought upwardly in a direction isolating from the liquid crystal panel, by operating the displacement adjusting screws. Therefore, when it is not possible to correct deformation by pressurizing the frame-type chassis and the panel holding frame, e.g. when deformation occurs because of a foreign matter entered into the back face of the liquid crystal panel, the frame-type chassis and the panel holding frame can be brought upwardly for the height of the foreign matter. As a result, the deformation caused due to the entered foreign matter can be corrected.

Moreover, the liquid crystal module may be structured in a following manner. That is, the panel holding frame is mounted to four corners of the frame-type chassis; a screw hole is opened in a back face of each of the panel holding frames; the displacement adjusting screws are screwed upwardly into the screw holes, whereby the panel holding frames can be displaced in a direction approaching to or isolating from the screen of the liquid crystal panel.

In this structure, the screw hole is opened in a back face of each of the panel holding frames that are mounted to the four corners of the frame-type chassis, and the displacement adjusting screws are screwed upwardly into the screw holes. Thus, even if the frame-type chassis and the panel holding frames are twisted and deformed in a prescribed direction so that a prescribed part becomes higher or lower than the liquid crystal panel, it is possible to correct the deformed part by pressurizing the low part from the back face side of the panel holding frame, for example.

Further, the liquid crystal module may be structure in a following manner. That is, the panel holding frame is formed substantially in an L-shape with a missing corner part when viewed two-dimensionally, and such panel holding frame is provided in four corners of the frame-type chassis; one each of the screw hole is opened in four corners of the surface of the shield plate in an area corresponding to the missing corner part of the L-shape; the displacement adjusting screw is screwed into each of the screw holes; and a top face of the frame-type chassis is pressurized by tips of the displacement adjusting screws, whereby the frame-type cassis can be displaced.

In this structure, the displacement adjusting screw is screwed into a single screw hole that is provided in each of the four corners of the shield plate. Thus, the number of displacement adjusting screws provided therein can be reduced. For this, the time and effort for processing the screw holes in the shield plate can be reduced.

Further, the displacement adjusting screws directly press the frame-type chassis in the corner parts of the L-shapes of the panel holding frames with this structure. This makes it possible to pressurize the four corners of the frame-type chassis in a well balanced manner, so that the frame-type chassis can be displaced stably.

Furthermore, the liquid crystal module may be structured in a following manner. That is, the panel holding frame is formed substantially in an L-shape with a missing corner part when viewed two-dimensionally, and such panel holding frame is provided in four corners of the frame-type chassis; the screw hole is opened in two corners out of four corners of the surface of the shield plate which correspond to the missing corner part of the L-shape; the displacement adjusting screw is screwed into each of the screw holes; and a top face of the frame-type chassis is pressurized by tips of the displacement adjusting screws, whereby the frame-type cassis can be displaced.

In this structure, two corners among the four corners of the frame-type chassis and the panel holding frames are used for adjusting the displacement. Thus, particularly when there is a deformed part generated on one side of the frame-type chassis and the panel holding frames, it is possible to adjust the deformation by pressurizing such deformed part with the displacement adjusting screws. As a result, it requires less number of areas to be adjusted.

Moreover, the liquid crystal module may be structure in a following manner. That is, the screw hole is opened in four corners of the shield plate on a surface side of the panel holding frame by corresponding to provided positions of the panel holding frame; the displacement adjusting screw is screwed with each of the screw holes for allowing the displacement adjusting screw to pressurize the top face of the panel holding frame, whereby the panel holding frame can be displaced in a direction approaching to or isolating from a screen of the liquid crystal panel with a cooperate work of the displacement adjusting screws and the displacement adjusting screws provided upwardly.

With this structure, when the displacement adjusting screw is pressurizing the panel holding frame, the displacement adjusting screw provided upwardly is set back. Meanwhile, when the displacement adjusting screw is fixed at a prescribed position, the upward displacement adjusting screw can be screwed in so as to pressurize the panel holding frame from the back face side thereby to securely hold the panel holding frame in that position. Therefore, the adjusted position can be maintained securely. This structure can be used in cases where highly precise adjustment is required.

Furthermore, the panel holding frames are fixed by being sandwiched between the displacement adjusting screws from the above and the displacement adjusting screws provided upwardly. Therefore, the positions of the panel holding frames and the frame-type chassis can be maintained under a stable state even after adjusting the displacement.

Further, the liquid crystal module may be structure in a following manner. That is, a burring protruded from a surface of the shield plate towards a back side is formed on the surface of the shield plate; the screw hole is opened in the burring; and the displacement adjusting screw is screwed into the screw hole.

In this structure, the burring protruded from the surface of the shield plate towards a back side is formed on the four corners of the shield plate. Thus, the shield plate can be reinforced, and the strength of the liquid crystal module can be secured thereby.

Further, the frame-type chassis and the panel holding frames may be formed with a same material.

When the frame-type cassis and the panel holding frames are manufactured by resin molding, for example, it is possible to manufacture those with less time and effort since both the frame-type chassis and the panel holding frames are formed with the same material. Further, it requires less time and effort for preparing the materials.

Furthermore, the frame-type chassis and the panel holding frame may be formed with different materials, and the panel holding frame may be fixed to the frame type cassis with a frame fixing member.

In this structure, the frame-type chassis and the panel holding frame are formed with different materials. Thus, even when the whole figure has a complicated shape, the frame-type chassis and the panel holding frames may be manufactured separately and assembled thereafter. With this, manufacture thereof becomes easier.

Further, a liquid crystal display device according to another exemplary embodiment of the present invention may include the liquid crystal module according to one aspect of the present invention enclosed between a front-side device casing and a back-side device casing, wherein a tool inserting hole, into which a tool fitted with the displacement adjusting screw can be inserted, is opened in the front-side device casing in an area corresponding to the displacement adjusting screw.

In this structure, the tool inserting hole is opened in the front-side device casing, so that a tool such as a driver can be inserted from the tool inserting hole to fasten or loosen the displacement adjusting screw. Therefore, even after the product is mounted into the device, the displacement adjusting screw can be adjusted from the tool inserting hole of the front-side device casing. Furthermore, since the displacement adjusting screw is exposed, it is possible to adjust it to the optimum position while checking the state of the unevenness by actually driving the screen. As a result, unevenness on the screen display, which is generated due to distortion stresses generated during the time of processing or assembling, can be eliminated or reduced easily within a short time.

Furthermore, a liquid crystal display device of the present invention may include the liquid crystal module according to one aspect of the present invention enclosed between a front-side device casing and a back-side device casing, wherein: a tool inserting hole is opened in the back-side device casing in each area corresponding to the displacement adjusting screws; and each of the tool inserting holes is so formed that a tool fitted with the displacement adjusting screw can be inserted.

In this structure, the tool inserting hole is opened in the back-side device casing, so that a tool such as a driver can be inserted from the tool inserting hole to fasten or loosen the displacement adjusting screw. Therefore, even after the product is mounted into the device, the displacement adjusting screw can be adjusted from the tool inserting hole of the front-side device casing. Furthermore, since the displacement adjusting screw is exposed, it is possible to adjust it to the optimum position while checking the state of the unevenness by actually driving the screen. As a result, unevenness on the screen display, which is generated due to distortion stresses generated during the time of processing or assembling, can be eliminated or reduced easily within a short time.

Moreover, a liquid crystal display device of the present invention may include the liquid crystal module according to one aspect of the present invention enclosed between a front-side device casing and a back-side device casing, wherein: a tool inserting hole is opened in the front-side device casing and the back-side device casing, respectively, in areas corresponding to the displacement adjusting screws; and each of the tool inserting hole is so formed that a tool that fitted with the displacement adjusting screw can be inserted.

In this structure, the tool inserting hole is opened in the front-side device casing and the back-side device casing, respectively, so that a tool such as a driver can be inserted from the tool inserting holes to fasten or loosen the displacement adjusting screws. Therefore, even after the product is mounted into the device, the displacement adjusting screws can be adjusted from the tool inserting holes of the front-side device casing and the back-side device casing. Furthermore, since the displacement adjusting screw is exposed, it is possible to adjust it to the optimum position while checking the state of the unevenness by actually driving the screen. As a result, unevenness on the screen display, which is generated due to the distortion stresses generated during the time of processing or assembling, can be eliminated or reduced easily within a short time.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

### INDUSTRIAL APPLICABILITY

The present invention can be applied to a liquid crystal module and a liquid crystal display device including that liquid crystal module.

What is claimed is:

1. A liquid crystal module, comprising a liquid crystal panel for displaying an image, a backlight for irradiating light to the liquid crystal panel, and a shield plate for shielding electromagnetic waves from inside and outside, wherein the backlight is mounted to a frame-type chassis, and a panel holding frame for holding the liquid crystal panel is provided to the frame-type chassis, wherein
the frame-type chassis and the panel holding frame are structured to be capable of being displaced in a direction approaching to or isolating from a screen of the liquid crystal panel by a displacement adjusting member that is engaged either with the frame-type chassis or with the panel holding frame.

2. The liquid crystal module as claimed in claim 1, wherein:
the displacement adjusting member is configured with a displacement adjusting screw; a screw hole is opened at least in one corner on a surface of the shield plate; the displacement adjusting screw is screwed into the screw hole; and a top face of either the frame-type chassis or the panel holding frame is pressurized by a tip of the displacement adjusting screw, whereby the frame-type chassis and the panel holding frame can be displaced.

3. The liquid crystal module as claimed in claim 2, wherein:
the panel holding frame is formed substantially in an L-shape when viewed two-dimensionally, and such panel holding frame is provided in four corners of the frame-type chassis; two each of the screw holes are opened in four corners of the surface of the shield plate in an areas corresponding to the panel holding frames; the displacement adjusting screw is screwed into each of the screw holes; and a top face of the panel holding frame is pressurized by tips of the displacement adjusting screws, whereby the panel holding frames can be displaced.

4. The liquid crystal module as claimed in claim 2, wherein:
two each of the screw holes are opened in four corners of the panel holding frame; screw inserting holes are opened in four corners on the surface of the shield plate by corresponding to the screw holes; the displacement adjusting screws are screwed into the screw inserting holes, and the displacement adjusting screws are screwed into the screw holes of the panel holding frame, whereby the panel holding frame can be displaced in a direction approaching to or isolating from the screen of the liquid crystal panel.

5. The liquid crystal module as claimed in claim 2, wherein:
the panel holding frame is mounted to four corners of the frame-type chassis; a screw hole is opened in a back face of each of the panel holding frames; the displacement adjusting screws are screwed upwardly into the screw holes, whereby the panel holding frames can be displaced in a direction approaching to or isolating from the screen of the liquid crystal panel.

6. The liquid crystal module as claimed in claim 2, wherein:
the panel holding frame is formed substantially in an L-shape with a missing corner part when viewed two-dimensionally, and such panel holding frame is provided in four corners of the frame-type chassis; one each of the screw hole is opened in four corners of the surface of the shield plate in an area corresponding to the missing corner part of the L-shape; the displacement adjusting screw is screwed into each of the screw holes; and a top face of the frame-type chassis is pressurized by tips of the displacement adjusting screws, whereby the frame-type chassis can be displaced.

7. The liquid crystal module as claimed in claim 2, wherein:
the panel holding frame is formed substantially in an L-shape with a missing corner part when viewed two-dimensionally, and such panel holding frame is provided in four corners of the frame-type chassis; the screw hole is opened in two corners out of four corners of the surface of the shield plate which correspond to the missing corner part of the L-shape; the displacement adjusting screw is screwed into each of the screw holes; and a top face of the frame-type chassis is pressurized by tips of the displacement adjusting screws, whereby the frame-type cassis can be displaced.

8. The liquid crystal module as claimed in claim 2, wherein:
the screw hole is opened in four corners of the shield plate on a surface side of the panel holding frame by corresponding to provided positions of the panel holding frame; the displacement adjusting screw is screwed with each of the screw holes for allowing the displacement adjusting screw to pressurize the top face of the panel holding frame, whereby the panel holding frame can be displaced in a direction approaching to or isolating from a screen of the liquid crystal panel with a cooperate work of the displacement adjusting screws and the displacement adjusting screws provided upwardly.

9. The liquid crystal module as claimed in claim 2, wherein: a burring protruded from a surface of the shield plate towards a back side is formed on the surface of the shield plate; the screw hole is opened in the burring; and the displacement adjusting screw is screwed into the screw hole.

10. The liquid crystal module as claimed in claim 1, wherein the frame-type chassis and the panel holding frame are formed with a same material.

11. The liquid crystal module as claimed in claim 2, wherein the frame-type chassis and the panel holding frame are formed with different materials, and the panel holding frame is fixed to the frame-type chassis with a frame fixing member.

12. A liquid crystal display device comprising the liquid crystal module of claim 1 enclosed between a front-side device casing and a back-side device casing, wherein
a tool inserting hole, into which a tool fitted with the displacement adjusting screw can be inserted, is opened in the front-side device casing in an area corresponding to the displacement adjusting screw.

13. A liquid crystal display device comprising the liquid crystal module of claim 5 enclosed between a front-side device casing and a back-side device casing, wherein:
a tool inserting hole is opened in the back-side device casing in each area corresponding to the displacement adjusting screws; and each of the tool inserting holes is so formed that a tool fitted with the displacement adjusting screw can be inserted.

14. A liquid crystal display device comprising the liquid crystal module of claim 8 enclosed between a front-side device casing and a back-side device casing, wherein:
a tool inserting hole is opened in the front-side device casing and the back-side device casing, respectively, in areas corresponding to the displacement adjusting screws; and each of the tool inserting hole is so formed that a tool that fitted with the displacement adjusting screw can be inserted.
